(19) United States
(12) Patent Application Publication
(10) Pub. No.: US 2010/0188380 A1
(43) Pub. Date: Jul. 29, 2010

(54) DISPLAY DEVICE INCLUDING A DISPLAY ELEMENT OF DOT MATRIX TYPE AND A DRIVE METHOD THEREOF

(75) Inventor: Masaki Nose, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/751,750

(22) Filed: Mar. 31, 2010

Related U.S. Application Data
(63) Continuation of application No. PCT/JP2007/070093, filed on Oct. 15, 2007.

(51) Int. Cl. G06F 3/038

(52) U.S. Cl. 345/209; 345/213

(57) ABSTRACT

A display device includes a display element of a dot matrix-type having a display material with memory properties, a drive circuit that drives a pixel of the display element and a control circuit that controls the drive circuit, the control circuit includes an initialization step for applying a voltage pulse to initialize a pixel to be rewritten to bring about an initial gradation state and a gradation step for applying a voltage pulse to change the gradation state of a pixel, and the gradation step includes a plurality of sub-steps having a plurality of execution times and in the plurality of sub-steps, an alternating-current voltage pulse is formed in a pixel to be rewritten and the period of the alternating-current voltage pulse is varied in accordance to a gradation to be written within the range of the sub-step.

### CROSS-REFERENCE TO RELATED APPLICATIONS

This application is a continuation application and is based upon PCT/JP2007/070093, filed on Oct. 15, 2007, the entire contents of which are incorporated herein by reference.

### FIELD

The embodiment discussed herein is related to a display device including a display element of dot matrix type and a drive method thereof.

### BACKGROUND

In recent years, the development of electronic paper has been promoted in companies, universities, etc. Applied fields expected to utilize electronic paper have been proposed, including a variety of fields, such as electronic books, a sub-display for mobile terminal equipment, and a display part of an IC card. One promising method of electronic paper is one that uses a cholesteric liquid crystal. A cholesteric liquid crystal has excellent characteristics, such as the ability to semipermanently hold a display (memory property), vivid color display, high contrast, and high resolution.

Cholesteric liquid crystals are also referred to as chiral nematic liquid crystals, which form a cholesteric phase in which molecules of the nematic liquid crystal are in the form of a helix by adding a comparatively large amount (a few tens of percent) of additives (chiral material) having chiral property to the nematic liquid crystal.

FIG. 1A and FIG. 1B are diagrams explaining the states of the cholesteric liquid crystals. As illustrated in FIG. 1A and FIG. 1B, a display element 10 that utilizes cholesteric liquid crystals has an upper side substrate 11, a cholesteric liquid crystal layer 12, and a lower side substrate 13. Cholesteric liquid crystals have a planar state in which incident light is reflected as illustrated in FIG. 1A and a focal conic state in which incident light is transmitted as illustrated in FIG. 1B, and theses states are maintained stably even if there is no electric field.

In the planar state, light having a wavelength in accordance with the helical pitch of liquid crystal molecules is reflected. A wavelength λ at which reflection is maximum is expressed by the following expression where n is an average refractive index and p is a helical pitch

λ=n·p.

On the other hand, a reflection band Δλ differs considerably depending on a refractive index anisotropy Δn of liquid crystal.

In the planar state, a “bright” state, i.e., white can be displayed because incident light is reflected. On the other hand, in the focal conic state, a “dark” state, i.e., black can be displayed because light having passed through the liquid crystal layer is absorbed by a light absorbing layer provided under the lower side substrate 13.

Next, a method of driving a display element that utilizes cholesteric liquid crystals is explained.

FIG. 2 illustrates an example of a voltage-reflection characteristic of general cholesteric liquid crystals. The horizontal axis represents a voltage value (V) of a pulse voltage to be applied with a predetermined pulse width between electrodes that sandwich cholesteric liquid crystals and the vertical axis represents a reflectivity (%) of cholesteric liquid crystals. A curve P of a solid line illustrated in FIG. 2 represents the voltage-reflectivity characteristic of cholesteric liquid crystals when the initial state is the planar state and a curve FC of a broken line represents the voltage-reflectivity characteristic of cholesteric liquid crystals when the initial state is the focal conic state.

In FIG. 2, if a predetermined high voltage VP100 (for example, ±36 V) is applied between the electrodes to generate a relatively strong electric field in the cholesteric liquid crystal, the helical structure of the liquid crystal molecules is undone completely and a homeotropic state is brought about, where all of the molecules align in the direction of the electric field. Next, when the liquid crystal molecules are in the homeotropic state, if the applied voltage is reduced rapidly from VP100 to a predetermined low voltage (for example, VF0=±4 V) to reduce the electric field in the liquid crystal almost to zero, the helical axis of the liquid crystal becomes perpendicular to the electrode and the planar state is brought about, where light in accordance with the helical pitch is reflected selectively.

On the other hand, if a predetermined low voltage VF100b (for example, ±24 V) is applied between electrodes to generate a relatively weak electrical field in the cholesteric liquid crystal, a state is brought about where the helical structure of the liquid crystal molecules is not undone completely. In this state, if the applied voltage is reduced rapidly from VF100b to the low voltage VF0 to rapidly reduce the electric field in the liquid crystal almost to zero, or to gradually remove the electric field by applying a strong electric field, the helical axis of the liquid molecule becomes parallel with the electrode and the focal conic state where incident light is transmitted is brought about.

Further, if the electric field is removed rapidly by applying an electric field of intermediate strength, the planar state and the focal conic state coexist in a mixed condition and it possible to display a halftone.

A display is produced by utilizing the above-mentioned phenomena.

The principles of a driving method based on the voltage response characteristic described above are explained with reference to FIG. 3A to FIG. 3C.

FIG. 3A illustrates the pulse response characteristic when the pulse width of a voltage pulse is a few tens of ms, FIG. 3B illustrates the pulse response characteristic when the pulse width of a voltage pulse is 1.88 ms, and FIG. 3C illustrates the pulse response characteristic when the pulse width of a voltage pulse is 0.94 ms. In each figure, a voltage pulse to be applied to a cholesteric liquid crystal is illustrated on the upper side and the voltage-reflectivity characteristic is illustrated on the lower side, and the horizontal axis represents a voltage (V) and the vertical axis represents reflectivity (%). As a well known drive pulse of a liquid crystal, a voltage pulse is a combination of a positive polarity pulse and a negative polarity pulse in order to prevent the liquid crystal from deteriorating due to polarization.

As illustrated in FIG. 3A, when the pulse width is great, as illustrated by the solid line, if the initial state is the planar state, the state changes into the focal conic state when the voltage is raised to a certain range and if the voltage is further raised, the state changes into the planar state again. As illustrated by the broken line, when the initial state is the focal conic state, the state gradually changes into the planar state as the pulse voltage is raised.

When the pulse width is great, the voltage pulse, at which the state changes into the planar state whether the initial state is the planar state or the focal conic state, is ±36 V in FIG. 3A. With a pulse voltage in the middle of this range, the state is such that the planar state and the focal conic state coexist in a mixed condition, and therefore, a halftone can be obtained.

On the other hand, when the pulse width is 2 ms as illustrated in FIG. 3B, when the initial state is the planar state, the reflectivity remains unchanged when the voltage pulse is about 10 V, however, at higher voltages, the state is such that the planar state and the focal conic state coexist in a mixed condition, and therefore, the reflectivity is reduced. The amount of reduction in reflectivity increases as the voltage is increased, however, when the voltage is increased than 36 V, the amount of reduction in reflectivity becomes constant. This is also the same when the initial state is a state where the planar state and the focal conic state coexist in a mixed condition. Because of this, when the initial state is the planar state, if a voltage pulse having a pulse width of 2 ms and a pulse voltage of about 20 V is applied once, the reflectivity is reduced by a certain amount. In this manner, in the state where the planar state and the focal conic state coexist in a mixed condition and the reflectivity is reduced by a small amount, if a voltage pulse having a pulse width of 2 ms and a pulse voltage of about 20 V is further applied, the reflectivity is reduced further. If this is repeated, the reflectivity is reduced to a predetermined value.

As illustrated in FIG. 3C, when the pulse width is 1 ms, the reflectivity is reduced when a voltage pulse is applied in a manner similar to that when the pulse width is 2 ms, however, the amount of reduction in reflectivity is smaller compared to the case where the pulse width is 2 ms.

From the above, it can be thought that if a pulse of 36 V having a pulse width of several ten milliseconds is applied, the state planar state is brought about and if a gradation pulse of about ten-something to 20 V is applied, a state where the planar state and the focal conic state coexist in a mixed condition is brought about and the reflectivity is reduced, and the amount of reduction in reflectivity depends on the cumulative time of the gradation pulse.

As to the multi-gradation display method by cholesteric liquid crystal, there have been proposed various driving methods. The method of driving a multi-gradation display by cholesteric liquid crystal is divided into a dynamic driving method and a convention driving method.

Japanese Laid-open Patent Publication No. 2001-228459 describes a dynamic driving method. However, the dynamic driving method uses complicated drive waveforms, and therefore, requires a complicated control circuit and a driver IC and also requires a transparent electrode of the panel, having a low resistance, resulting in a problem that the manufacturing cost is increased. Further, the dynamic driving method has a problem that power consumption is large.

Y.-M. Zhu, D-K. Yang, Cumulative Drive Schemes for Bistable Reflective Cholesteric LCDs, SID 98 DIGEST, pp 798-801, 1998 describes the conventional driving method. This Non-patent document describes a method of driving the state gradually from a planar state to a focal conic state, or from the focal conic state to the planar state at a comparatively high semi-moving picture rate by making use of the cumulative time inherent in liquid crystal and adjusting the number of times of application of a short pulse.

However, in the driving method described in this non-patent document, because of such a high semi-moving picture rate, the drive voltage is as high as 50 to 70 V, and this is a factor that increases the cost. Further, the “two phase cumulative drive scheme” described in this non-patent document uses the cumulative times in two directions, that is, the cumulative time to the planar state and the cumulative time to the focal conic state using the two stages, that is, the “preparation phase” and the “selection phase”, and therefore, there is a problem of display quality, such as an increase in granularity of a halftone. Further, a fine pulse is applied a number of times, and therefore, the driving method described in this non-patent document has a problem that power consumption is large.

Japanese Laid-open Patent Publication No. 2000-147466 and Japanese Laid-open Patent Publication No. 2000-171837 describe a method of driving a fast-forward mode that applies resetting to the focal conic state. This driving method has an advantage that a comparatively high contrast can be obtained compared to the above-mentioned driving method, however, the writing after resetting requires a high voltage that is difficult to achieve by a general-purpose STN driver, and further, the writing is cumulative one toward the planar state, and therefore, the crosstalk to the half-selected or non-selected pixel becomes a problem. In addition, this driving method also has a problem that power consumption is large because a fine pulse is applied a number of times.

When a gradation is set by making use of the cumulative time using the conventional driving method, there can be conceived of a method of varying the pulse width, in addition to the method of adjusting the number of times of application of a short pulse as described above. The method of varying the pulse width is more advantageous than the method of adjusting the number of times of application of a short pulse from the standpoint of suppression of power consumption. Hereinafter, the method of setting a gradation by varying the pulse width to change the cumulative time is referred to as a PWM (Pulse Width Modulation) method.

Japanese Laid-open Patent Publication No. 04-62516 describes a configuration in which a positive polarity pulse and a negative polarity pulse having different pulse widths are applied in a liquid crystal display device, although the display device does not use cholesteric liquid crystal. FIG. 4A to FIG. 4C illustrate examples of pulses of different pulse widths described in cited document 4, wherein the pulse width is longer in order of FIG. 4A, FIG. 4B and FIG. 4C. The pulses illustrated in FIG. 4A to FIG. 4C have the same length of one unit pulse and have a positive polarity pulse and a negative polarity pulse of different pulse widths. By making use of such a pulse, it is possible to prevent deterioration due to the polarization of liquid crystal.

### SUMMARY

According to a first aspect of the embodiment, a display device includes: a display element of dot matrix type having a display material with memory properties; a drive circuit that drives a pixel of the display element; and a control circuit that controls the drive circuit, wherein the control circuit includes: an initialization step for applying a voltage pulse to initialize a pixel to be rewritten to bring about an initial gradation state; and a gradation step for applying a voltage pulse to change the gradation state of a pixel, and wherein the gradation step includes a plurality of sub-steps having a plurality of execution times and in the plurality of sub-steps, an alternating-current voltage pulse is formed in a pixel to be rewritten and the period of the alternating-current voltage pulse is varied in accordance to a gradation to be written within the range of the sub-step.

According to a second aspect of the embodiment, a driving method of a display device, the device including: a display element of dot matrix type including a display material with memory properties; a drive circuit that drives a pixel of the display element; and a control circuit that controls the drive circuit, wherein the control circuit includes an initialization step for applying a voltage pulse to initialize a pixel to be rewritten to bring about the initial gradation state and a gradation step for applying a voltage pulse to change the gradation state of the pixel, wherein the gradation step includes a plurality of sub-steps including a plurality of execution times, in the plurality of sub-steps, an alternating-current voltage pulse is formed in a pixel to be rewritten, and the period of the alternating-current voltage pulse is varied in accordance with a gradation to be written within the range of the sub-step.

The object and advantages of the embodiment will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram explaining a planar state of cholesteric liquid crystal;

FIG. 1B is a diagram explaining a focal conic state of cholesteric liquid crystal;

FIG. 2 is a diagram explaining a state change of cholesteric liquid crystal by a pulse voltage;

FIG. 3A is a diagram explaining a change in reflectivity by a pulse having a large voltage and a great pulse width to be applied to cholesteric liquid crystal;

FIG. 3B is a diagram explaining a change in reflectivity by a pulse having an intermediate voltage and a narrow pulse width to be applied to cholesteric liquid crystal;

FIG. 3C is a diagram explaining a change in reflectivity by a pulse having an intermediate voltage and a narrower pulse width to be applied to cholesteric liquid crystal;

FIG. 4A is a diagram illustrating an example in which the pulse width of a symmetric pulse to be applied to liquid crystal is narrow;

FIG. 4B is a diagram illustrating an example in which the pulse width of a symmetric pulse to be applied to liquid crystal is intermediate;

FIG. 4C is a diagram illustrating an example in which the pulse width of a symmetric pulse to be applied to liquid crystal is great;

FIG. 5 is a diagram illustrating an example of a symmetric pulse to be applied to cholesteric liquid crystal;

FIG. 6 is a diagram explaining the occurrence of crosstalk when a symmetric pulse having a long pulse length is applied to cholesteric liquid crystal;

FIG. 7 is a diagram illustrating a laminated structure of a cholesteric liquid crystal element of a color display device in an embodiment;

FIG. 8 is a diagram illustrating a structure of one cholesteric liquid crystal element of a color display device in an embodiment;

FIG. 9 is a diagram illustrating a general configuration of a color display device in an embodiment;

FIG. 10 is a diagram illustrating an image write operation in a first embodiment;

FIG. 11A is a diagram illustrating a driver output voltage in reset processing in the first embodiment;

FIG. 11B is a diagram illustrating a liquid crystal applied voltage in reset processing in the first embodiment;

FIG. 12A is a diagram explaining reset processing in the first embodiment;

FIG. 12B is a diagram explaining reset processing in the first embodiment;

FIG. 12C is a diagram explaining reset processing in the first embodiment;

FIG. 13A is a diagram illustrating a driver output voltage in gradation write processing in the first embodiment;

FIG. 13B is a diagram illustrating a liquid crystal applied voltage in gradation write processing in the first embodiment;

FIG. 14A is a diagram illustrating gradation pulses H1 to H8 to be output in a frame F1 of gradation write processing in the first embodiment;

FIG. 14B is a diagram illustrating gradation pulses H9 to H11 to be output in a frame F2 of gradation write processing in the first embodiment;

FIG. 14C is a diagram illustrating a gradation pulse H12 to be output in a frame F3 of gradation write processing in the first embodiment;

FIG. 15A is a diagram illustrating data of bit planes BP1 to BP8 to be supplied in the frame F1 of gradation write processing in the first embodiment;

FIG. 15B is a diagram illustrating data of bit planes BP9 to BP11 to be supplied in the frame F2 of gradation write processing in the first embodiment;

FIG. 15C is a diagram illustrating data of a bit plane BP12 to be supplied in the frame F3 of gradation write processing in the first embodiment;

FIG. 15D is a diagram illustrating a cumulative value (time) for a gradation level in gradation write processing in the first embodiment;

FIG. 16 is a time chart illustrating the operation of a common driver and a segment driver in reset processing at the time of a first step;

FIG. 17A is a time chart illustrating the operation of a common driver and a segment driver in gradation write processing of the frame F1 in a second step;

FIG. 17B is a time chart illustrating the operation of a common driver and a segment driver in gradation write processing of the frame F1 in the second step;

FIG. 18 is a time chart illustrating the operation of a common driver and a segment driver in gradation write processing of the frame F2 in the second step;

FIG. 19 is a time chart illustrating the operation of a common driver and a segment driver in gradation write processing of the frame F3 in the second step;

FIG. 20 is a diagram illustrating a relationship between an input gradation and an output gradation in the first embodiment;

FIG. 21 is a diagram illustrating a relationship between a gradation level and a cumulative value of gradation pulse in the first embodiment;

FIG. 22 is a diagram illustrating a relationship (tone curve) between a gradation level and brightness in the first embodiment;

FIG. 23 is flowchart for realizing a draft mode in a display device in the first embodiment;

FIG. 24 is a diagram illustrating the image write operation in a second embodiment;

FIG. 25A is a time chart illustrating the operation of a common driver and a segment driver in a second step in the second embodiment;

FIG. 25B is a time chart illustrating the operation of a common driver and a segment driver in the second step in the second embodiment;

FIG. 26 is a diagram illustrating a change in operating current when a gradation is written by varying the cumulative time only by the number of pulses;

FIG. 27 is a diagram illustrating a change in operating current in the first embodiment;

FIG. 28 is a diagram illustrating a change in operating current when the write timing of an RGB liquid crystal layer is shifted in the first embodiment.

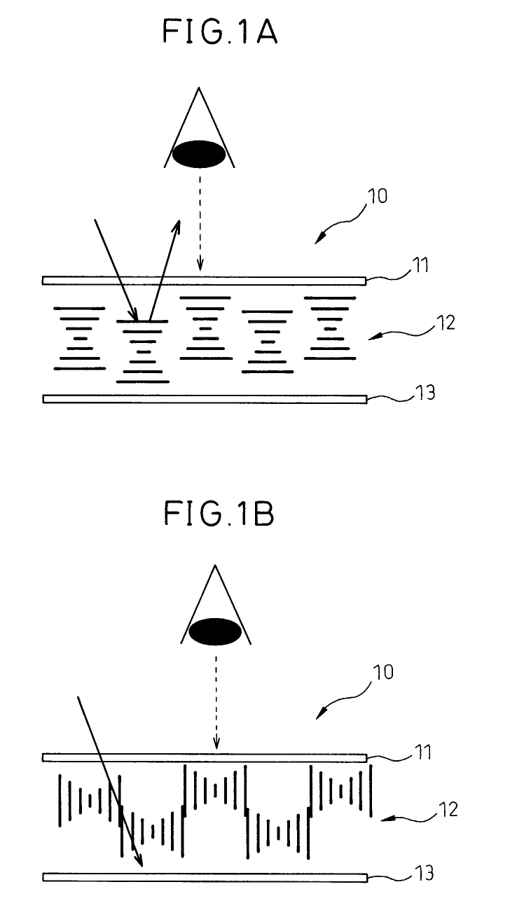

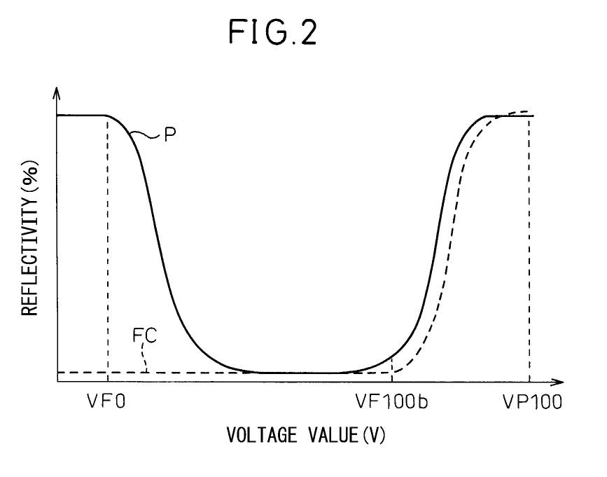

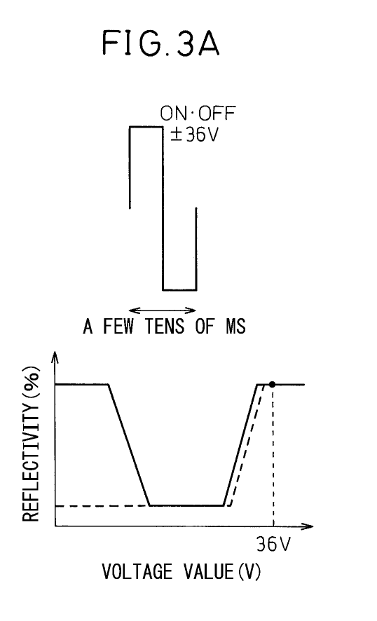

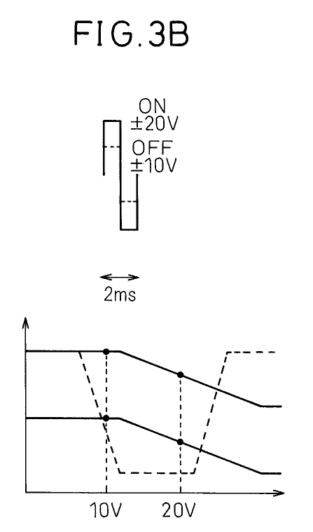

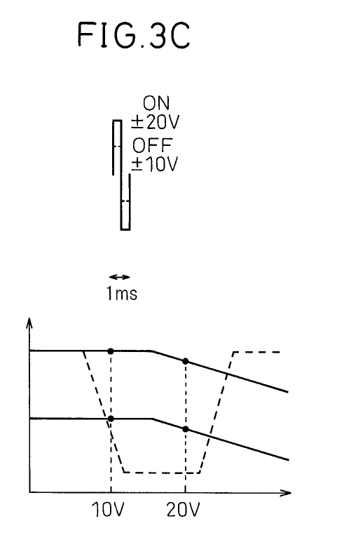

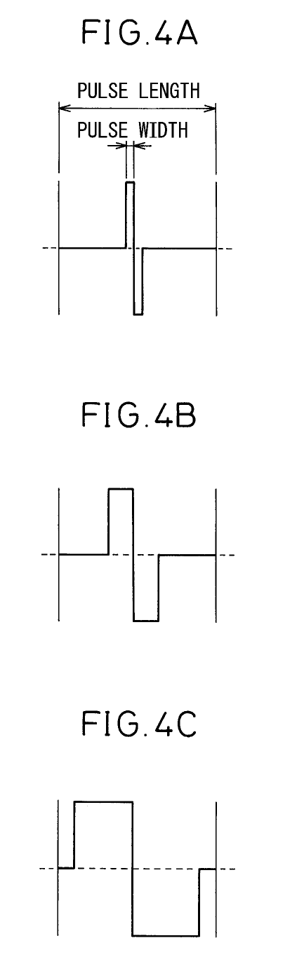

### DESCRIPTION OF EMBODIMENTS

Before describing the embodiments, the problems of the above-mentioned conventional driving methods will be described.

As described above, the methods of varying a gradation by varying the cumulative time include the method of varying the number of times of application of a short pulse and the method of varying the pulse width (PWM method), each having advantages and disadvantages. The method of adjusting the number of times of application of a short pulse has a disadvantage that power consumption is large, as described above, however, it has an advantage that a picture of the entire image can be recognized at an early stage because the image gradually appears during the period of write, an advantage that the crosstalk due to a half-selected pulse can be lessened, and an advantage that the amount of used memory of the bit plane is small.

On the other hand, the PWM method has an advantage that control is comparatively simple, and the control circuit and the drive circuit are simplified and can be realized at a low cost, in addition to an advantage that power consumption can be reduced. However, the PWM method has a disadvantage that it takes time to recognize a picture of the whole of an image because of low-speed scan, a disadvantage that the amount of memory of the bit plane is large, and a disadvantage that the crosstalk due to a half-selected voltage is large.

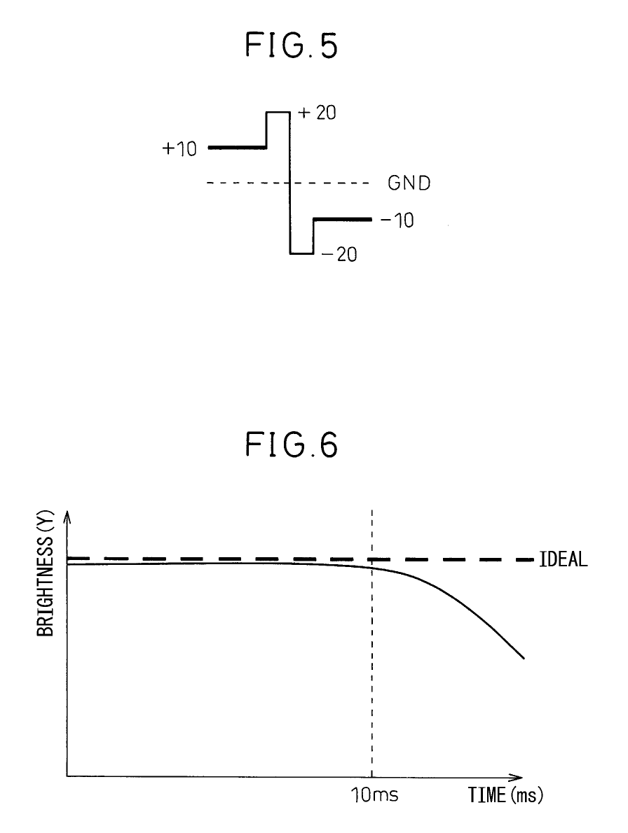

Among the disadvantages of the PWM method, a particularly problematic one is the disadvantage that the crosstalk due to a half-selected voltage is large. Cholesteric liquid crystal changes its state when a large voltage is applied whether positive or negative. In a liquid crystal display device that makes use of cholesteric liquid crystal, a scan line that extends in the transverse direction is written one by one and a scan line to be written is shifted, and this action is repeated. Because of this, a ground level voltage is applied to a selected scan line and an intermediate voltage (for example, 15 V) is applied to the other non-selected scan lines. To a data line that extends in the longitudinal direction, a large voltage (20 V) is applied, however, if the voltage of the part other than a pulse width is reduced to the ground level, a large voltage (−15 V) having the opposite polarity is applied to a pixel of a non-selected scan line as a result, and the state of the liquid crystal changes. In order to prevent such a change, when the PWM method is performed with a liquid crystal display device that makes use of cholesteric liquid crystal, as illustrated in FIG. 5, in the positive polarity phase, a pulse having a base voltage of +10 V and a pulse voltage of +20 V is used and in the negative polarity phase, a pulse having a base voltage of −10 V and a pulse voltage of −20V is used. Due to this, to a pixel of a non-selected scan line, +5 V or −5 V is applied as a result, and the state of the liquid crystal does not change. In a selected scan line, to the pulse part, +20 V or −20 V is applied and to the other base part, +10 V or −10 V is applied.

FIG. 6 is a diagram illustrating a change in pulse width and brightness (mixture ratio of the focal conic state) when a pulse of 10 V is applied. As illustrated schematically, it is seen that when the pulse width is narrow, even if a voltage of ±10 V is applied, the state of the liquid crystal does not change, however, if the pulse width exceeds 10 ms, the brightness gradually reduces. This is called a crosstalk.

When the pulse width of the pulse illustrated in FIG. 5 is changed in order to realize, for example, 16 gradations, the minimum pulse width is determined by the response characteristic, and therefore, for example, when the pulse width is set to 0.5 ms, it is necessary to set the pulse length to 16 ms or more because of the two positive and negative polarity phases. Because of this, there arises a problem that the crosstalk becomes large.

According to the embodiments, the above problems are solved and a device including a display element of new dot matrix type that satisfies both power consumption and display quality and a method of driving the device are realized.

In a display device and a method of driving a display element of dot matrix type of the embodiments, a gradation step for applying a gradation pulse to each scan line includes a plurality of sub-steps having a plurality of execution times and in the plurality of sub-steps, an alternating current voltage pulse is formed in a pixel to be rewritten and the period of the alternating current voltage pulse is varied in accordance with a gradation to be rewritten in the rang of the sub-steps.

The application of a gradation pulse to vary the cumulative time is performed by varying the pulse period (pulse width), that is, by the PWM method, however, the application of a gradation pulse is performed in the plurality of sub-steps, and therefore, the occurrence of crosstalk due to an increase in the pulse width of a half-selected voltage can be suppressed.

Due to this, both the reduction in power consumption and the suppression of crosstalk can be achieved at the same time.

The plurality of sub-steps can be performed continuously in a state where a scan line is selected or in different frames.

When the plurality of sub-steps are performed in different frames, if a frame of a sub-step in which the number of gradations to be written is larger is performed first, it is possible to recognize a picture of the whole of an image at an early stage, and therefore, it may also be possible to temporarily stop writing when the writing of predetermined sub-steps is completed and then determine whether or not to continue further writing.

It is desirable that the initialization voltage pulse and the gradation pulse have the positive polarity phase and the negative polarity phase of the same length and the switching of the phases be once.

A different pulse width of a gradation pulse in the sub-step can be determined by data to be supplied to a segment driver IC.

A different basic pulse width of a gradation pulse in the plurality of sub-steps can be controlled by switching the latch periods of the segment driver IC.

A typical example of a display material is liquid crystal that forms a cholesteric phase, however, the embodiments can be applied to any display material as long as it has a similar characteristic. In the case of cholesteric liquid crystal, the initialization gradation state is the planar state and a gradation state other than the initialization gradation state is a state where the planar state and the focal conic state coexist mixedly and a brightness of a halftone is determined by the coexistence ratio.

When the gradation is varied by varying the cumulative time by the method of displaying multiple gradations using cholesteric liquid crystal, there used to be a problem that low gradations cannot be realized satisfactorily because the gradation level and the cumulative time are not in a complete proportional relationship. Because of this, the difference of the cumulative time from that of the neighboring gradation is made larger when the coexistence ratio of the focal conic state is large than when the coexistence ratio of the focal conic state is small. Due to this, even if the relationship between the cumulative time and the gradation level is nonlinear, it is possible to display the entire range of gradation, and therefore, display quality is improved.

It is possible for a display device to produce a color display by comprising a laminated structure in which the plurality of display elements that exhibit a plurality of kinds of reflected light are stacked. In this case, it is desirable that the operation timing at which the plurality of display elements are brought into the initialization gradation state and the operation timing at which they are brought into a gradation state other than the initialization gradation state be different in the display device. When the operation timings are different, it is possible to reduce the maximum current value.

The embodiments are explained below with reference to the drawings.

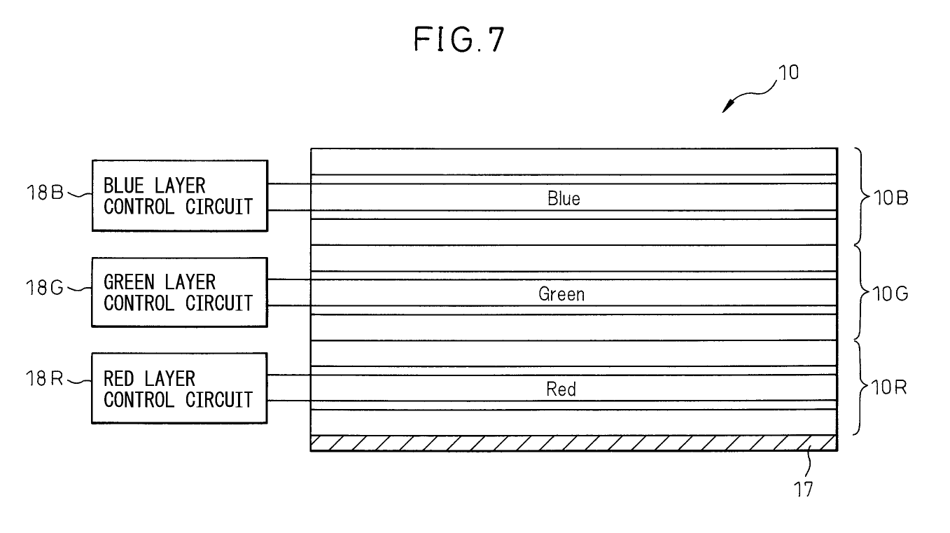

FIG. 7 is a diagram illustrating the configuration of a display device 10 used in an embodiment. As illustrated in FIG. 7, in the display device 10, three panels are stacked into a layer, that is, a panel 10B for blue, a panel 10G for green and a panel 10R for red in order from the view side, and a light absorbing layer 17 is provided under the panel 10R for red. The panels 10B, 10G and 10R have the same configuration, however, the liquid crystal material and chiral material are selected and the content of the chiral material is determined so that the center wavelength of reflection of the panel 10B is blue (about 480 nm), the center wavelength of reflection of the panel 10G is green (about 550 nm), and the center wavelength of reflection of the panel 10R is red (about 630 nm). The panels 10B, 10G and 10R are driven by a blue layer control circuit 18B, a green layer control circuit 18G and a red layer control circuit 18R, respectively.

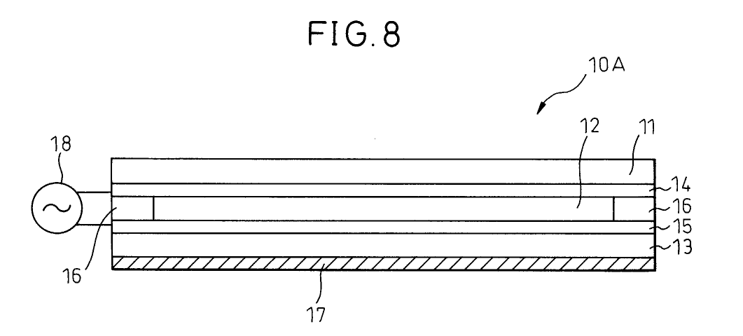

FIG. 8 is a diagram illustrating a basic configuration of the single panel 10A The panel used in the embodiment is explained with reference to FIG. 8.

As illustrated in FIG. 8, the display device 10A has an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that their electrodes are in opposition to each other and after a liquid crystal material is sealed in between, they are sealed with the sealing material 16. Within a liquid crystal layer 12, a spacer is arranged, however, it is not illustrated schematically. To the electrodes of the upper side electrode layer 14 and the lower side electrode layer 15, a voltage pulse signal is applied from a drive circuit 18 and due to this, a voltage is applied to the liquid crystal layer 12. A display is produced by applying a voltage to the liquid crystal layer 12 to bring the liquid crystal molecules of the liquid crystal layer 12 into the planar state or the focal conic state.

The upper side substrate 11 and the lower side substrate 13 both have translucency, however, the lower side substrate 13 of the panel 10R does not need to have translucency. Substrates having translucency include a glass substrate, however, in addition to the glass substrate, a film substrate of PET (polyethylene terephthalate) or PC (polycarbonate) may be used.

As the material of the electrode of the upper side electrode layer 14 and the lower side electrode layer 15, a typical one is, for example, indium tin oxide (ITO), however, other transparent conductive films, such as indium zinc oxide (IZO), can be used.

The transparent electrode of the upper side electrode layer 14 is formed on the upper side substrate 11 as a plurality of upper side transparent electrodes in the form of a belt in parallel with each another, and the transparent electrode of the lower side electrode layer 15 is formed on the lower side substrate 13 as a plurality of lower side transparent electrodes in the form of a belt in parallel with each another. Then, the upper side substrate 11 and the lower side substrate 13 are arranged so that the upper side electrode and the lower side electrode intersect each other when viewed in a direction vertical to the substrate and a pixel is formed at the intersection. On the electrode, a thin insulating film is formed. If the thin film is thick, it is necessary to increase the drive voltage and it becomes hard to configure the drive circuit by a general-purpose STN driver. Conversely, if no thin film is provided, a leak current flows, and therefore, there arises a problem that power consumption is increased. The dielectric constant of the thin film is about 5, which is considerably lower than that of the liquid crystal, and therefore, it is appropriate to set the thickness of the thin film to about 0.3 μm or less.

The thin insulating film can be realized by a thin film of SiO2 or an organic film of polyimide resin, acryl resin, etc., known as an orientation stabilizing film.

As described above, the spacer is arranged within the liquid crystal layer 12 and the separation between the upper side substrate 11 and the lower side substrate 13, that is, the thickness of the liquid crystal layer 12 is made constant. Generally, the spacer is a sphere made of resin or inorganic oxide, however, it is also possible to use a fixing spacer obtained by coating a thermoplastic resin on the surface of the substrate. An appropriate range of the cell gap formed by the spacer is 3.5 μm to 6 μm. If the cell gap is less than this value, reflectivity is reduced, resulting in a dark display, or conversely, if the cell gap is greater than this value, the drive voltage is increased and it becomes hard to drive by a general-purpose driver IC.

The liquid crystal composite that forms the liquid crystal layer 12 is cholesteric liquid crystal, which is nematic liquid crystal mixture to which a chiral material of 10 to 40 weight percent (wt %) is added. Here, the amount of the added chiral material is the value when the total amount of the nematic liquid crystal component and the chiral material is assumed to be 100 wt %.

As the nematic liquid crystal, various liquid crystal materials publicly known conventionally can be used, however, it is desirable to use a liquid crystal material the dielectric constant anisotropy (Δ∈) of which is in the range of 15 to 35. When the dielectric constant anisotropy is 15 or more, the drive voltage becomes comparatively low and if greater than the range, the drive voltage itself is reduced, however, the specific resistance is reduced and power consumption is increased particularly at high temperatures.

It is desirable for the refractive index anisotropy (Δn) to be 0.18 to 0.24. When the refractive index anisotropy is smaller than this range, the reflectivity in the planar state is reduced and when larger than this range, the scattering reflection in the focal conic state is increased and further, the viscosity is also increased and the response speed is reduced.

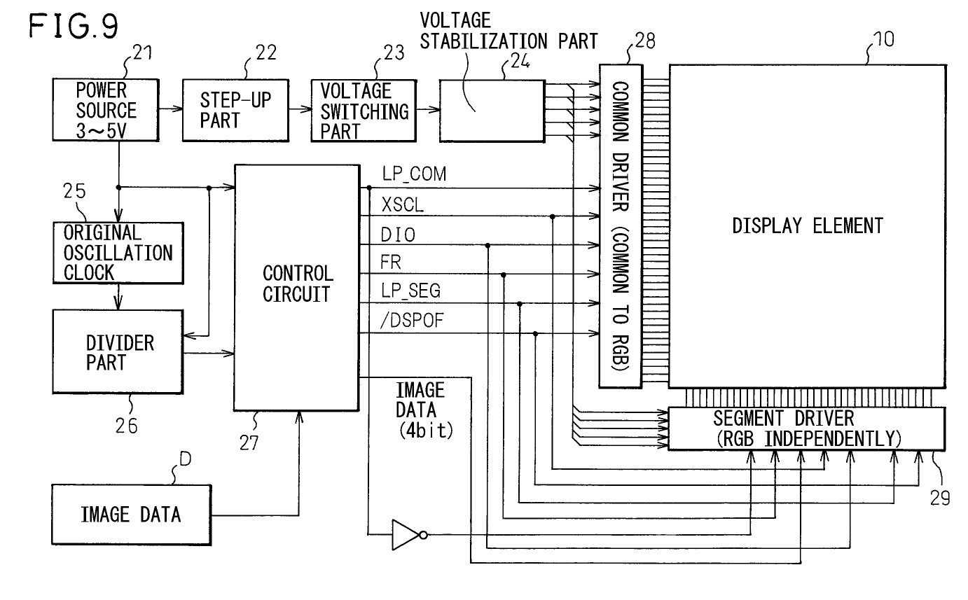

FIG. 9 is a diagram illustrating a configuration of the whole of the display device in the present embodiment. The display device 10 is in conformity with the A4 size/XGA specifications and has 1,024×768 pixels. A power source 21 outputs a voltage of, for example, 3 V to 5 V. A step-up part 22 steps up the input voltage from the power source 21 to 36 V to 40 V by a regulator, such as a DC-DC converter. Of course, it is preferable for the step-up regulator to have a high conversion efficiency for the characteristics of the display element. A voltage switching part 23 generates various voltages by resistor division etc. In order to switch between a reset voltage and a gradation write voltage in the voltage switching part 23, an analog switch having a high withstand voltage may be used, however, it is also possible to use a simple switching circuit including a transistor. It is desirable for a voltage stabilization part 24 to use a voltage follower circuit of an operational amplifier in order to stabilize various voltages supplied from the voltage switching part 23. It is desirable to use an operational amplifier having the characteristics highly resistant to a capacitive load.

An original oscillation clock 25 generates a base clock used as a base of the operation. A divider part 26 divides the base clock and generates various clocks necessary for the operation, to be described later.

A control circuit 27 generates a control signal based on the base clock, various clocks and image data D and supplies the signal to a common driver 28 and a segment driver 29.

The common driver 28 drives 768 scan lines and the segment driver 29 drives 1,024 data lines. Because image data given to each pixel of RGB are different, the segment driver 29 drives each data line independently. The common driver 28 drives the lines of RGB commonly. In the present embodiment, a general-purpose STN driver that output two values is used as a driver IC. Various general-purpose STN drivers can be used.

Image data to be input to the segment driver 29 is 4-bit data D0 to D3, which is a full color original image converted into data of RGB each having 16 gradations and 4,096 colors by the error diffusion method. As the gradation conversion method, a method by which high display quality can be obtained is preferable and a blue noise mask method can be used in addition to the error diffusion method.

Next, the image write operation in the first embodiment is explained.

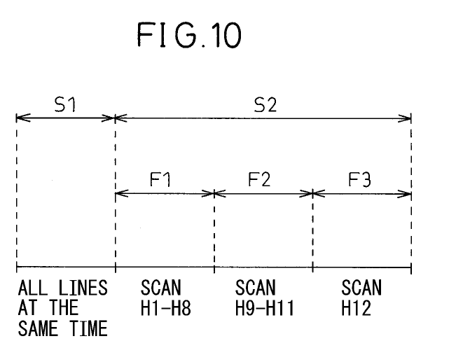

FIG. 10 is a diagram illustrating the image write operation. The image write operation has a first step S1 for simultaneously applying a pulse of ±36 V having a period of 10 ms to all of the pixels to bring the pixels into the planar state and a second step S2 for selectively applying a PWM gradation pulse to the pixels after the first step S1 to bring about a halftone state where the planar state and the focal conic state coexist mixedly. The second step S2 has three sub-steps. The second step S2 has three frames F1, F2 and F3. The first sub-step is executed in the frame F1, the second sub-step in the frame F2, and the third sub-step in the frame F3. As will be described later, in the first frame F1, gradation pulses H1 to H8 are applied sequentially to each scan line and after the pulses are applied to all of the lines, the frame F1 is completed. In the frame F2, gradation pulses H9 to H11 are applied sequentially to each scan line and after the pulses are applied to all of the lines, the frame F2 is completed. In the third frame F3, a gradation pulse H12 is applied sequentially to each scan line.

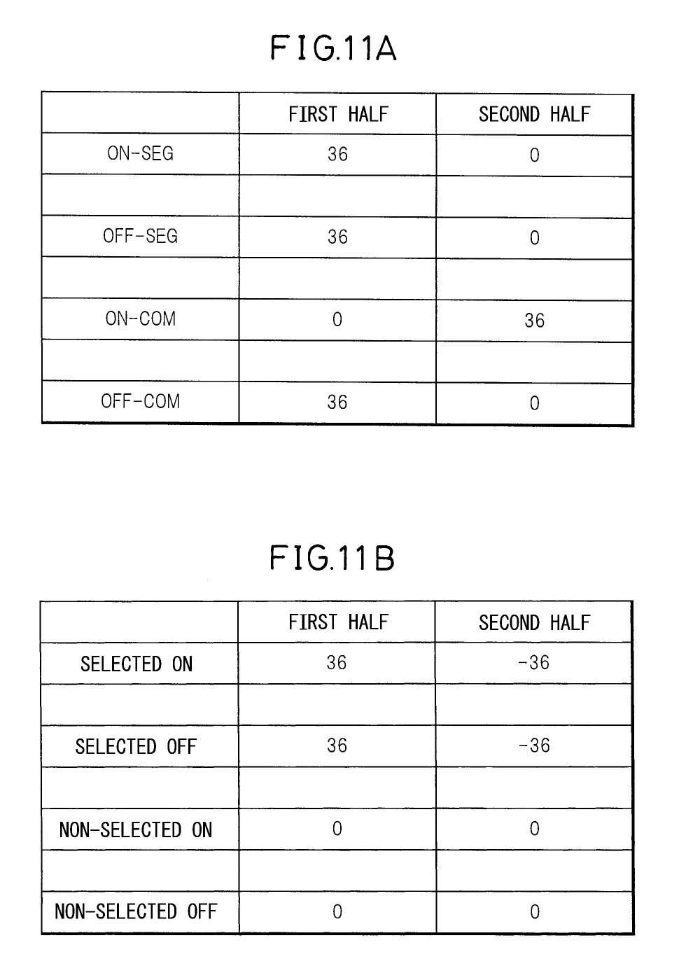

FIG. 11A illustrates ON output voltages and OFF output voltages of the common driver 28 and the segment driver 29 at the time of reset processing in the first step S1. FIG. 11B illustrates voltages to be applied to a pixel at the time of reset processing when the common driver 28 and the segment driver 29 output the voltages as illustrated in FIG. 11A.

As illustrated in FIG. 11A, voltages are switched as illustrated schematically between the first half in which a positive polarity pulse is applied (positive polarity phase) and the second half in which a negative polarity pulse is applied (negative polarity phase). In the first half, the ON output voltage (ON-SEG) and the OFF output voltage (OFF-SEG) of the segment driver 29 are 36 V, the ON output voltage (ON-COM) of the common driver 28 is 0 V, and the OFF output voltage (OFF-COM) of the common driver 28 is 36 V. In the second half, the ON and OFF output voltages of the segment driver 29 are 0 V, the ON output voltage of the common driver 28 is 36 V, and the OFF output voltage of the common driver 28 is 0 V.

In FIG. 11B, a selected ON pixel is selected when the ON output voltage is applied from the common driver 28, and illustrates a pixel to which the ON output voltage is applied from the segment driver 29 and 36 V is applied in the first half and −36 V in the second half. A selected OFF pixel is selected when the ON output voltage is applied from the common driver 28, and illustrates a pixel to which the OFF output voltage is applied from the segment driver 29 and 36 V is applied in the first half and −36 V in the second half. A non-selected ON pixel is selected when the OFF output voltage is applied from the common driver 28, and illustrates a pixel to which the ON output voltage is applied from the segment driver 29 and 0 V is applied both in the first half and in the second half. A non-selected OFF pixel is selected when the OFF output voltage is applied from the common driver 28, and illustrates a pixel to which the OFF output voltage is applied from the segment driver 29 and 0 V is applied both in the first half and in the second half.

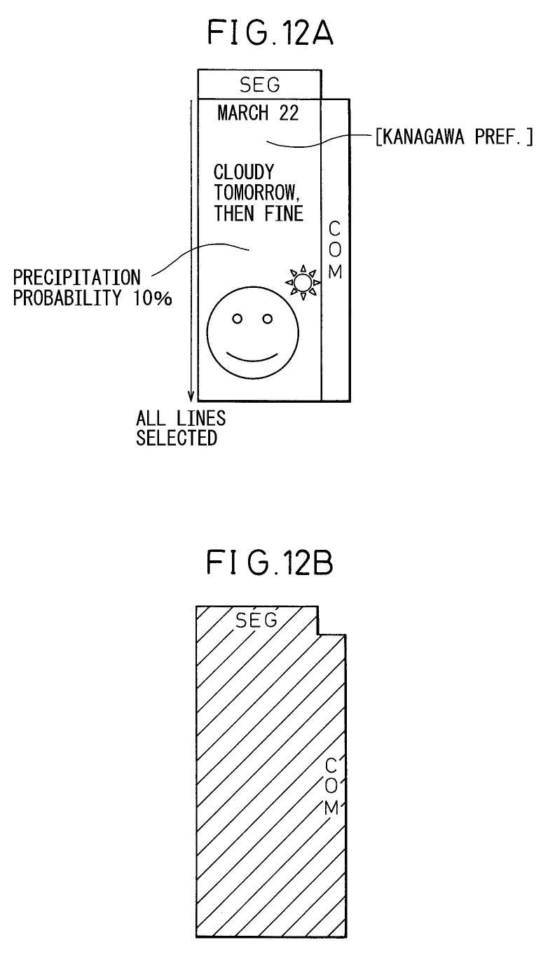

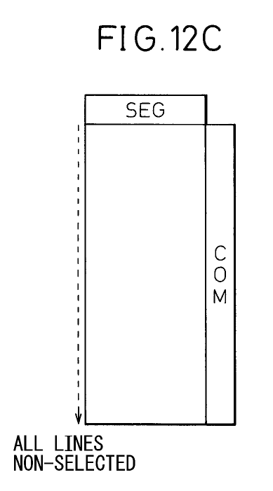

FIG. 12A to FIG. 12C are each a diagram for explaining an outline of reset processing.

First, an already written display such as illustrated in FIG. 12A is referred to. For this display, all of the output voltages of the segment driver 29 are set to the ground (GND) level and all of the output lines of the common driver 28 are brought into the selected state. In order to set all of the output voltages to the GND level, a voltage off function (/DSPOF) that a general-purpose STN driver has is asserted.

Next, when /DSPOF is negated, +36 is applied to all of the selected lines and all of the pixels are brought into the homeotropic state as illustrated in FIG. 12B.

Next, the voltage applied to all of the selected lines is inverted from +36 V to −36 V. The inversion of voltage is done by inverting the polarity signal (FR) of the general-purpose STN driver. Although there can be a number of combinations of voltage setting values of the common driver 28 and the segment driver 29 in this processing, the voltage settings as illustrated in FIG. 11A are preferable because it is possible to apply ±36 V to all of the pixels regardless of the output value from the segment driver 29.

Although the appropriate value of the application time of +36 V and −36 V in this case differs depending on the configuration of the display element, in the first embodiment, a pulse is used which has a pulse width of a few ms to a few tens of ms.

Finally, when −36 V is changed to 0 V, all of the pixels switch from the homeotropic state into the planar state and a white state as sown in FIG. 12C is brought about. It is preferable to use /DSPOF that the above-mentioned general-purpose STN driver has to switch from −36 V to 0 V. By using /DSPOF, a discharge is forcedly caused to occur in a short-circuit of the driver IC, and therefore, the discharge time during which the display element is charged/discharged can be reduced. The transition to the planar state requires the sharpness of a voltage pulse, and therefore, it is possible to reset the state into the planar state without fail even if the size of the display element is large by the forced discharge using /DSPOF.

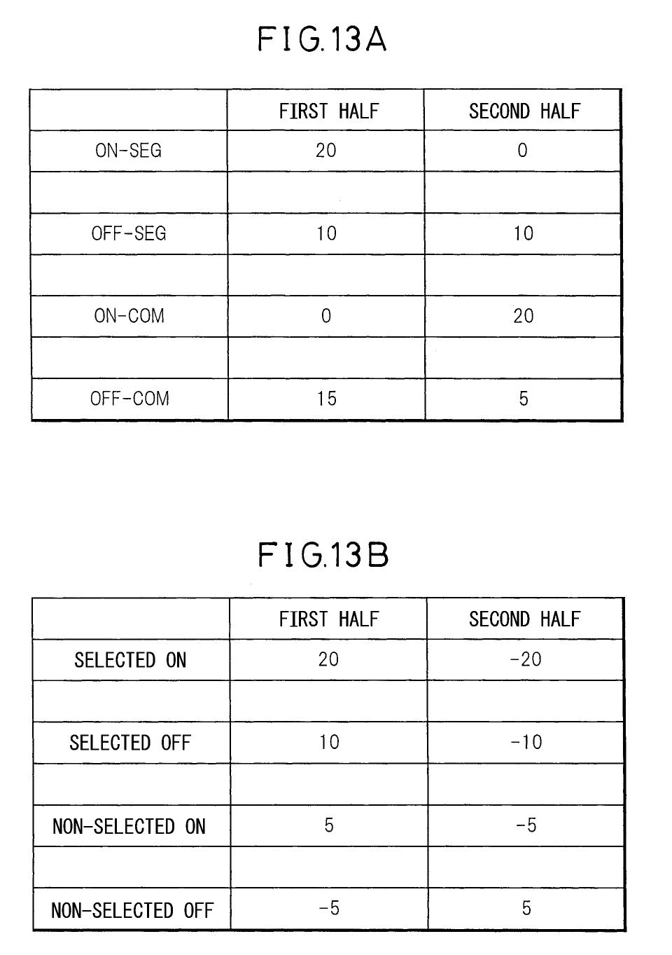

FIG. 13A illustrates ON and OFF output voltages of the common driver 28 and the segment driver 29 in the second step S2 for applying a PWM gradation pulse and FIG. 13B illustrates voltages to be applied to a pixel at the time of the application of a gradation pulse when the common driver 28 and the segment driver 29 output the voltages as illustrated in FIG. 13A.

When a gradation pulse is applied also, the voltages are switched as illustrated in FIG. 13A between the first half in which a positive polarity pulse is applied (positive polarity phase) and the second half in which a negative polarity pulse is applied. In the first half, the ON output voltage (ON-SEG) of the segment driver 29 is 20 V, the OFF output voltage (OFF-SEG) of the segment driver 29 is 10 V, the ON output voltage (ON-COM) of the common driver 28 is 0 V (GND), and the OFF output voltage (OFF-COM) of the common driver 28 is 15 V. In the second half, the ON output voltage of the segment driver 29 is 0 V, the OFF output voltage of the segment driver 29 is 10 V, the ON output voltage of the common driver 28 is 20 V, and the OFF output voltage of the common driver 28 is 5 V.

As illustrated in FIG. 13B, to the selected ON pixel, 20 V is applied in the first half and −20 V in the second half. To the selected OFF pixel, 10 V is applied in the first half and −10 V in the second half. To the non-selected ON pixel, 5 V is applied in the first half and −5 V in the second half. To the non-selected OFF pixel, −5 V is applied in the first half and 5 V in the second half.

As a result, from the applied voltages in FIG. 13B, to a selected pixel to which a gradation is written, a pulse of ±20 V is applied, to a half-selected (selected OFF) pixel to which a gradation is not written, a pulse of ±10 V is applied, and to a non-selected pixel, a pulse of ±5 V is applied.

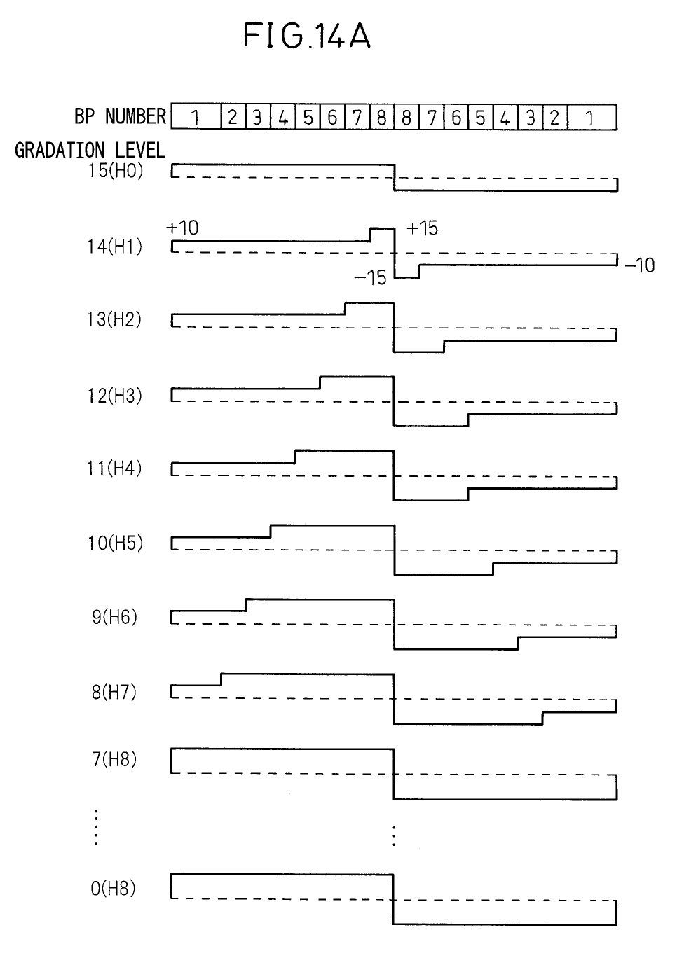

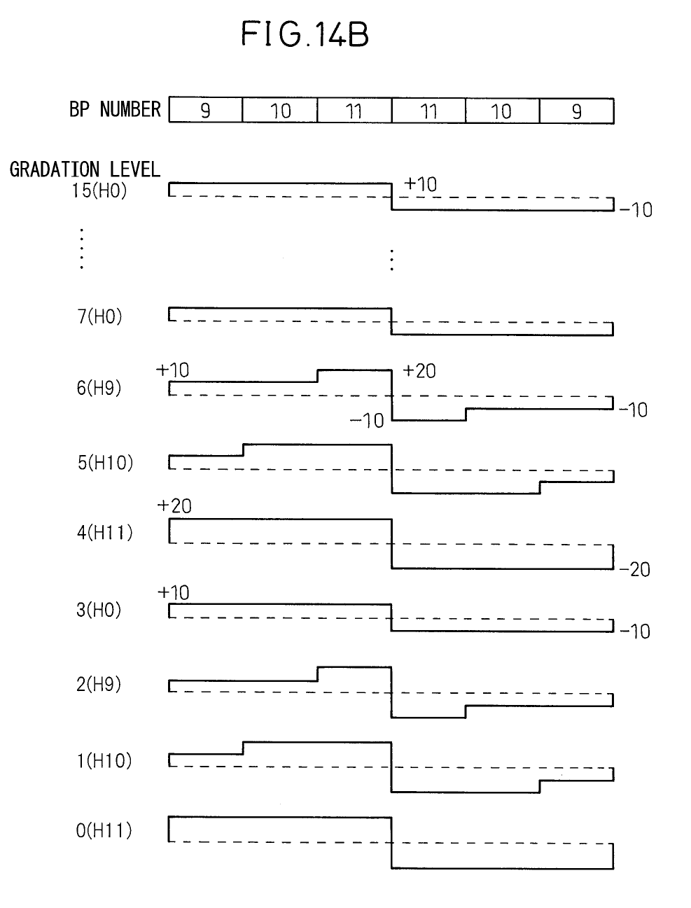

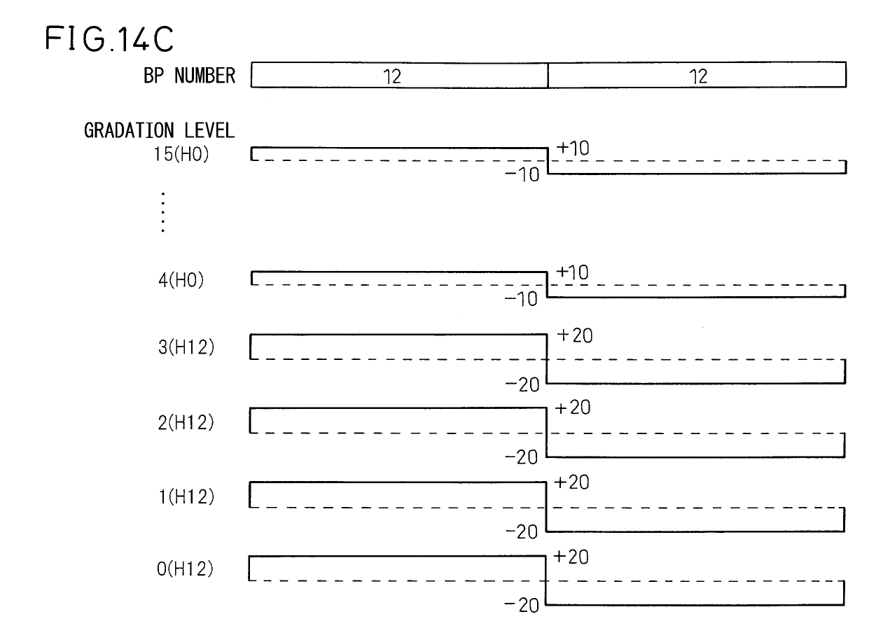

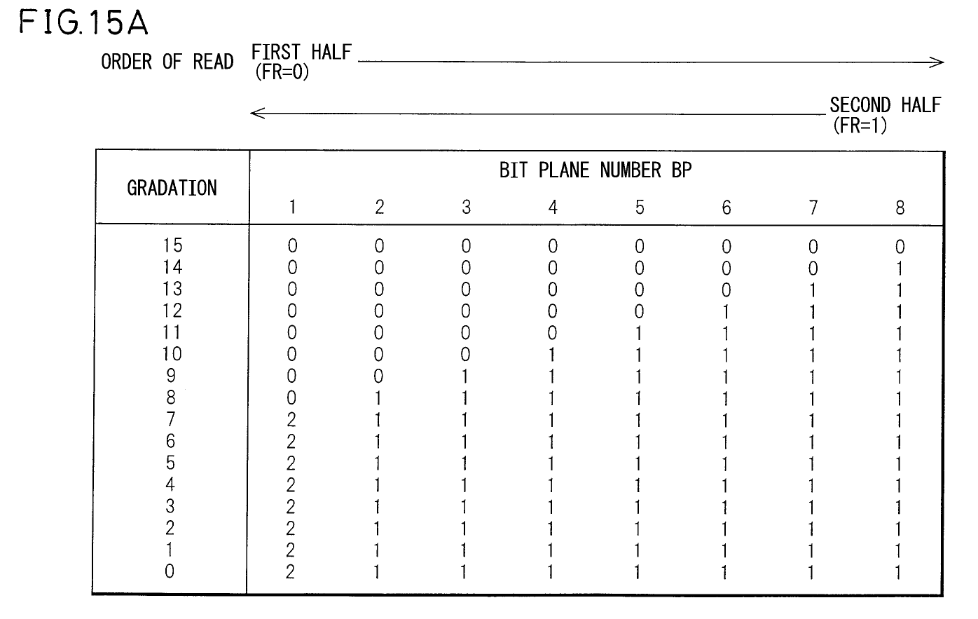

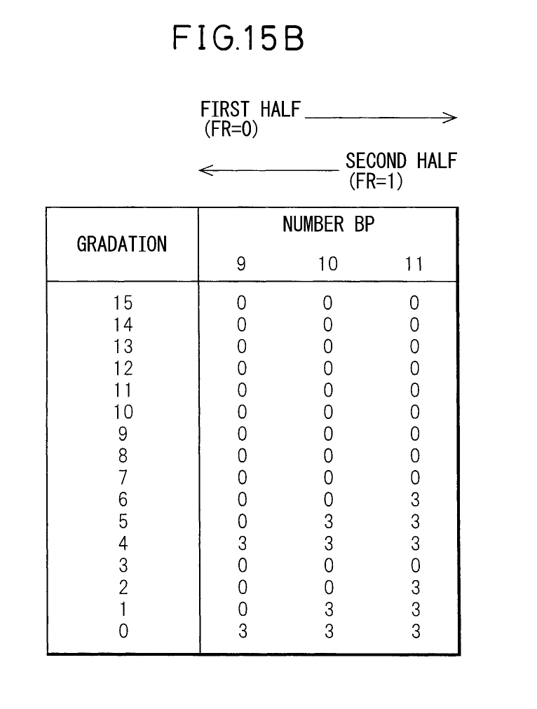

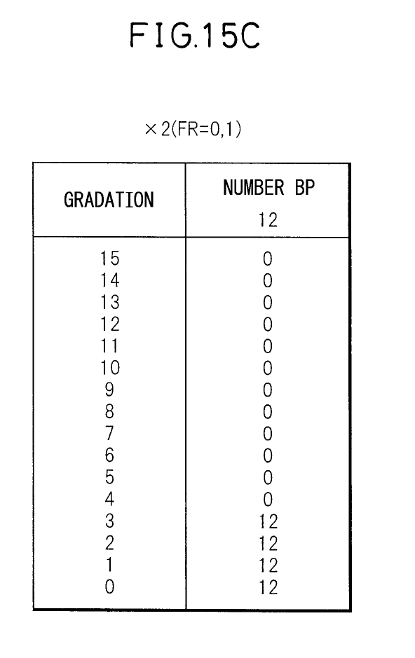

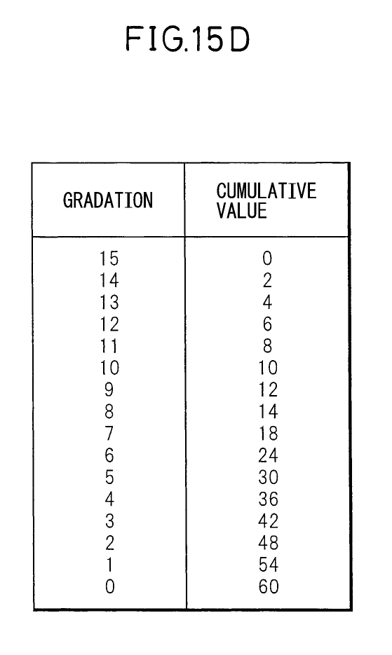

FIG. 14A to FIG. 14C are each a diagram illustrating a PWM gradation pulse in the first embodiment, wherein FIG. 14A illustrates the gradation pulses H1 to H8 in the frame F1, FIG. 14B illustrates the gradation pulses H9 to H11 in the second frame F2, and FIG. 14C illustrates the gradation pulse H12 in the frame F3. A pulse of ±10 V in the half-selected state is denoted by H0. FIG. 15A to FIG. 15C illustrate bit plane configurations to generate gradation pulses in the frames F1, F2 and F3 in order to realize the gradation pulses in FIG. 14A to FIG. 14C, and FIG. 15D illustrates a cumulative value (time) of gradation pulse in the frames F1, F2 and F3.

The general-purpose STN driver IC is a driver IC to write two values, and therefore, to a selected pixel, only a voltage to turn on (±20 V) or off (±10 V) can be output. In the first embodiment, the cumulative application time of write pulse to write 16 gradations is varied by the PWM method, that is, by varying the pulse width. However, when the pulse length is lengthened, the period of time of the half-selected state (selected ON period of time) in one time application of pulse is lengthened and crosstalk increases, and in order to prevent this, a frame is divided into three frames and a gradation pulse is applied and the pulse width of the gradation pulse is varied in the frames F1 and F2. In the frame F3, the pulse width of the gradation pulse is only one kind.

As illustrated in FIG. 14A, the gradation pulses H1 to H8 in the frame F1 are pulses that change from +10 V to +20 V, −20 V and −10 V in this order, and are symmetric with respect to the center. Here, the width of +20 V is the same as that of −20 V and this is the pulse width. The length of time including +10 V and −10 V is the pulse length. When it is assumed that the minimum pulse width is a base value t, the pulse widths of the gradation pulses H1 to H8 are 1t, 2t, 3t, 4t, 5t, 6t, 7t and 9t, respectively. The pulse H0 is a pulse that changes from +10 V to −10 V. Here, the part of +10 V and +20 V in the first half is referred to as a positive polarity phase and the part of −10 V and −20 V in the second half as a negative polarity phase.

To the pixel having a gradation level of 15, the pulse H10 is applied, to the pixels having gradation levels of 14, 13, 12, 11, 10, 9 and 8, the gradation pulses H1 to H7 are applied, respectively, and to the pixel having gradation levels of 7 to 0, the gradation pulse H8 is applied.

The frame F1 is configured by bit planes in the positive polarity phase with BP numbers 1 to 8 and bit planes in the negative polarity phase with BP numbers 8 to 1. The segment driver 29 outputs +10 V when the bit plane value is 0 and +20 V when the bit plane value is 1 or more in the positive polarity phase, and outputs −10 V when the bit plane value is 0 and −20 V when the bit plane value is 1 or more in the negative polarity phase.

The eight bit planes BP of the frame F1 store data as illustrated in FIG. 15A for each gradation level. When the positive polarity phase is output, in the order of the bit plane numbers 1, 2, 3, 4, 5, 6, 7 and 8, data is sent from the buffer (within the control circuit 27) that stores binary data of the image to the segment driver 29, and when the negative polarity phase is output, in the order of the bit plane numbers 8, 7, 6, 5, 4, 3, 2 and 1, data is sent from the buffer to the segment driver 29. In accordance with the data that is sent, the segment driver 29 outputs +10 V or +20 V at the time of the positive polarity phase and −10 V or −20 V at the time of the negative polarity phase.

For example, for the gradation level 15, all the data of the pit planes is 0, and therefore, the segment driver 29 outputs +10 V at the time of the positive polarity phase and outputs −10 V at the time of the negative polarity phase. For the gradation level 10, the data of the bit planes with numbers 1 to 3 is 0 and the data of the bit planes with numbers 4 to 8 is 1, and therefore, the segment driver 29 outputs +10 V in the bit planes with 1 to 3 and +10 V in the bit planes with numbers 4 to 8 in the positive polarity phase and outputs V in the bit planes with numbers 8 to 4 and −10 V in the bit planes with numbers 3 to 1 in the negative polarity phase. Due to this, the gradation pulse H10 as illustrated in FIG. 14A is obtained.

Similarly, for the gradation levels 7 or less, all the data of the bit planes is 1 or 2, and therefore, a gradation pulse of ±20 V is obtained.

Only the output period of the first bit plane is set double that of the other bit planes. Due to this, it is possible to reduce as much as possible an increase in the number of bit planes to obtain a desired gradation level and to reduce the capacity of the buffer that stores the bit planes. The control of the output time of the first bit plane can be realized easily by changing the latch period of the segment driver IC, such as by halving the clock frequency used to transfer an image to the segment driver. The pulse length of the gradation pulse of the frame F1 is 18t.

The frame F2 comprises the positive polarity phase having bit planes with numbers 9 to 11 and the negative polarity phase having bit planes with numbers 11 to 9 and the gradation pulse length is 18t. In the frame F2, to the gradation levels 15 to 7 and 3, H0 is applied, to the gradation levels 6 and 2, H9 is applied, to the gradation levels 5 and 1, H10 is applied, and to the gradation levels 4 and 0, H11 is applied. The data of the corresponding bit planes with numbers 9 to 11 is as illustrated in FIG. 15B.

Similarly, the frame F3 comprises the positive polarity phase and the negative polarity phase of the bit plane with number 12 and the gradation pulse length is 24t. In the frame F3, to the gradation levels 15 to 4, H0 is applied and to the gradation levels 3 to 0, H12 is applied. The data of the corresponding bit plane with number 12 is as illustrated in FIG. 15C.

By the application of the gradation pulses of the frames F1 to F3 described above, the cumulative values, that is, the cumulative times as illustrated in FIG. 15D are obtained for the respective gradation levels.

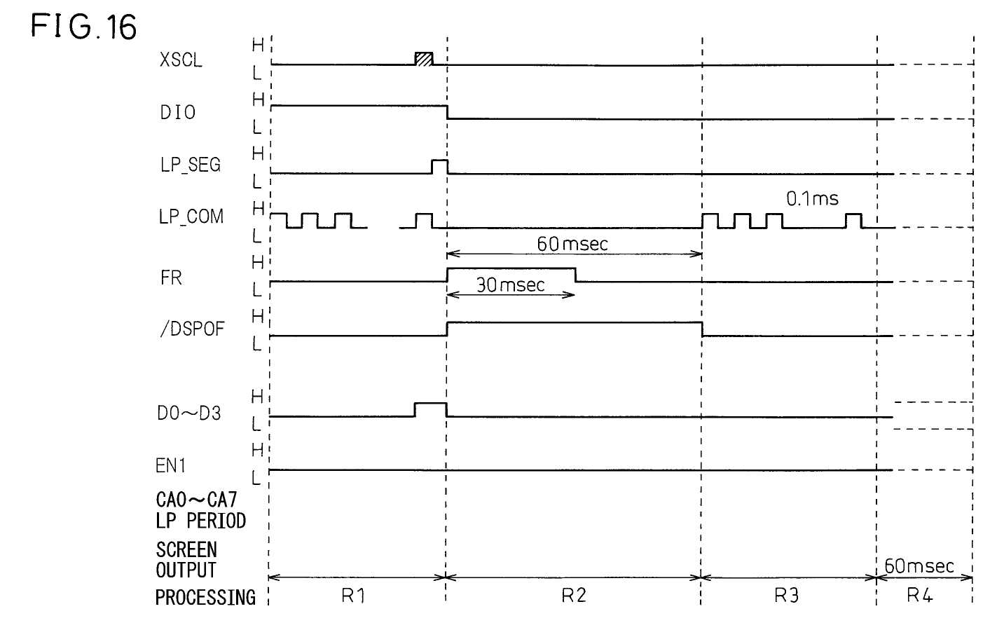

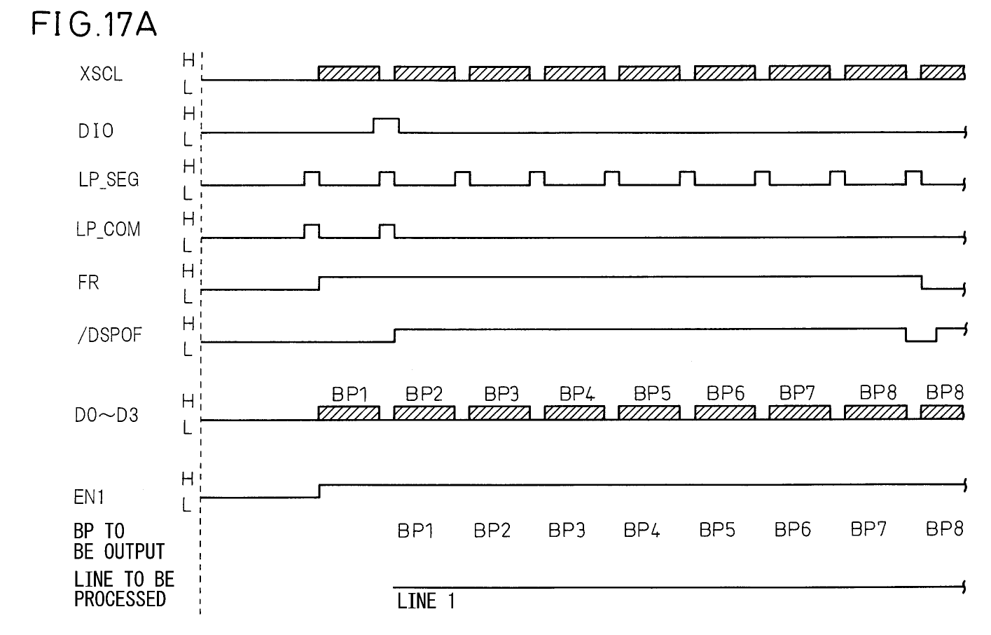

FIG. 16 is time chart illustrating the operation of the common driver 28 and the segment driver 29 in the reset processing at the time of the first step.

In processing R1, while /DSPOF (voltage OFF function) is kept at “L” and valid, DIO is turned to “H” to bring about the data transfer state. After that, LP_COM pulse is output continuously to bring all of the lines (768) of the common driver 28 into the selected state. Further, “H” data is sent to the segment driver 29 and then the segment driver 29 latches the data in accordance with LP_SEG to bring all of the lines (1,024) into the selected state.

In processing R2, /DSPOF is turned to “H” to cancel it and at the same time, FR is changed from “L” to “H”. Due to this, 0 V is applied to all of the scan lines, +36 V is applied to all of the data lines, and +36 V is applied to all of the pixels. After this state lasts for 30 ms or more, FR is inverted, that is, turned from “H” to “L”. Due to this, the output of the common driver 28 changes to +36 V and the output of the segment driver to 0 V, and −36 V is applied to all of the pixels. After this state lasts for 30 ms or more, /DSPOF is turned to “L” to be valid. Due to this, the output of the common driver 28 changes to 0 V, the voltage applied to all of the pixels changes to 0 V and the planar state is brought about.

In processing R3, while /DSPOF is kept at “L”, LP_COM is sent continuously and all of the lines of the common driver 28 are brought into the non-selected state.

Processing R4 is intended for a standby time during which the planar state becomes stable and the standby state lasts for a necessary time (60 ms in the figure).

After the above-described processing, gradation write processing, that is, the second step S2 is initiated.

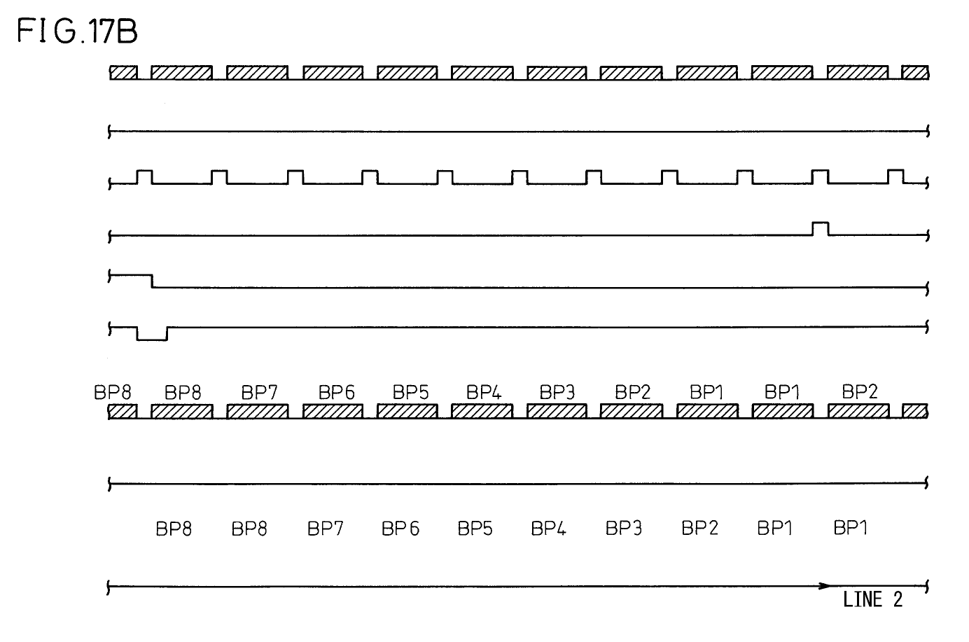

FIG. 17A and FIG. 17B are each a time chart illustrating gradation write processing in the frame F1.

First, LP_SEG and LP_COM are sent to bring about the non-selected state, then FR is turned to “H” and EN1 to “H”. Due to this, gradation write processing is initiated.

Data of the bit plane BP1 is sent and the segment driver 29 latches the BP1 data in accordance with LP_SEG. At the same time, DIO and LP_COM are sent and a state is brought about where the common driver 28 selects the first line. Then, /DSPOF is changed to “H”. Due to this, the part corresponding to the data of BP1 in the positive polarity phase, that is, the part of BP1 in the positive polarity phase in FIG. 14A is output. Consequently, +20 V is applied to the gradation levels 7 to 0 of the first line and +10 V is applied to the other gradation levels of the first line.

In parallel with the output of BP1, data of the bit plane BP2 is sent and the segment driver 29 latches the data of BP2 in accordance with LP_SEG similarly. At this time, LP_COM is not sent and the state where the common driver 28 has selected the first line is maintained. Due to this, the part of BP2 in the positive polarity phase is output. After that, the action to send the bit plane and the action of the segment driver 29 to latch and output the data are performed similarly for BP3 to BP7 in the positive polarity phase. In parallel with the output of BP7, BP8 in the positive polarity phase is sent. Then, when BP8 is latched, FR is changed to “L”. During a period of time of a few tens of ms to a few hundred of ms before and after the change of FR, /DSPOF is changed from “H” to “L” and then changed to “H” again. Due to this, the rush current is dispersed and power consumption can be reduced.

When BP8 is latched, BP8 in the positive polarity phase is output and in the meanwhile, BP8 in the negative polarity phase is sent and the segment driver 29 latches and outputs BP8 in the negative polarity phase in accordance with LP_SEG. At this time, FR is changed to “L”, and therefore, −20 V is applied to the selected pixel of the first line and −10 V to the non-selected pixel. After that, the action to send the bit plane and the action of the segment driver 29 to latch and output the bit plane are performed similarly for BP7 to BP1 in the negative polarity phase.

While BP1 is being output to the first line, BP1 in the positive polarity phase of the second line is sent and then latched and output. After that, the same action is performed for the second line and for all of the scan lines. Due to this, the processing of the first F1 is completed.

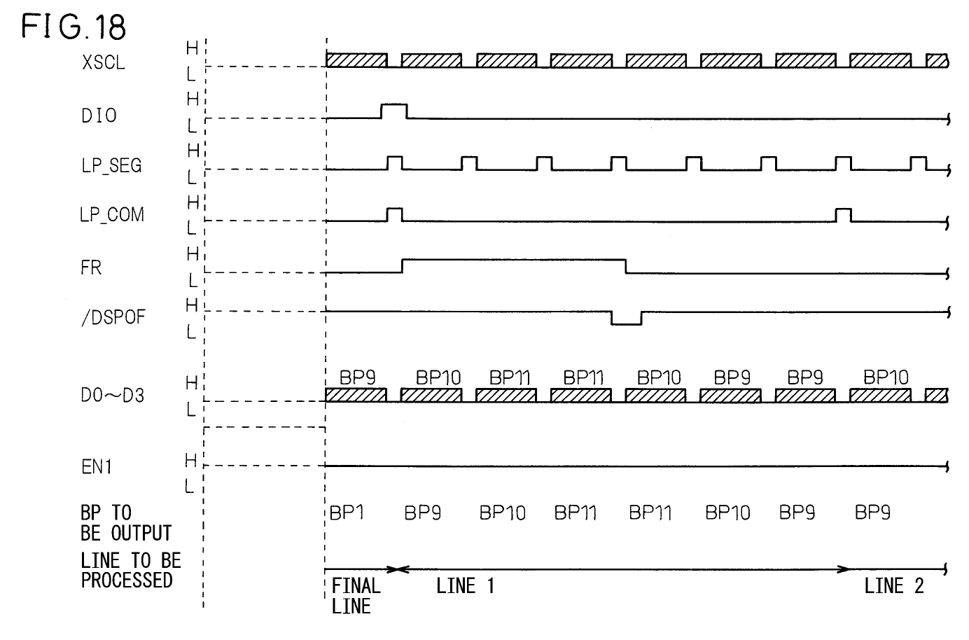

FIG. 18 is a time chart illustrating gradation write processing of the gradation pulses H9-H11 in the second frame F2. This processing is initiated by the action to send BP9 of the first line while the output of BP1 of the final line in the first frame F1 is being performed. This action is the same as the action of the frame F1 except in that the number of bit planes is three.

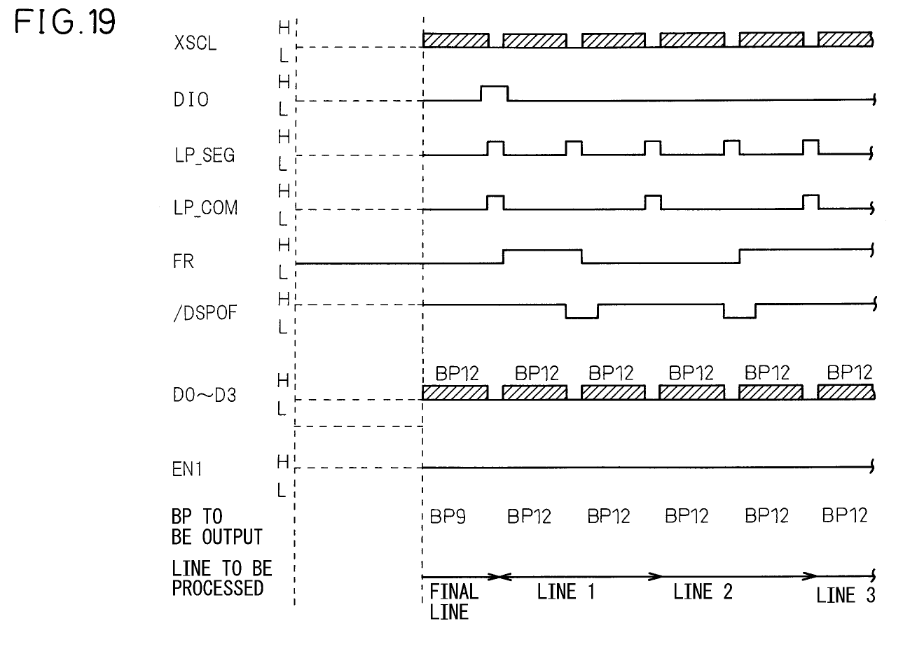

FIG. 19 is a time chart illustrating gradation write processing of the gradation pulse H12 in the third frame F3 and the action is the same as that described above except in that the number of bit plane is one.

BP8 in the first frame F1, BP11 in the second frame F2 and BP12 in the third frame F3 are output twice before and after the switching between the positive polarity phase and the negative polarity phase, however, it may also be possible to latch BP8, BP11 and BP12 once and double the time, and then switch the positive polarity phase and the negative polarity phase in the middle of the time.

By doing so, it is possible to reduce the amount of memory used because the bit planes are reduced by one in each frame.

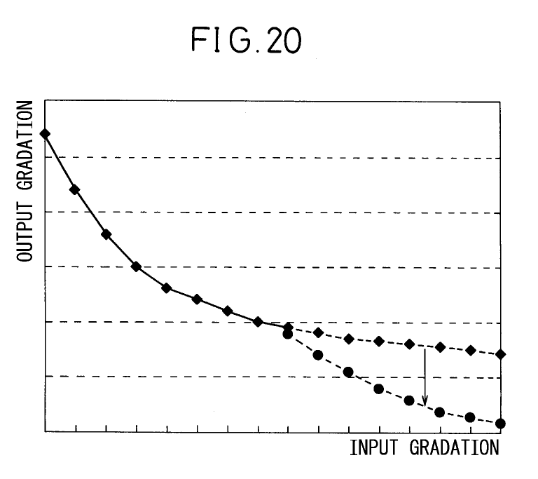

FIG. 20 is a diagram illustrating a relationship between input gradation and output gradation when the initial state is the planar state and a gradation pulse is applied to change the state into the focal conic state. Square points indicate a relationship when the gradation level and the cumulative value (time) are made proportional to each other and circular points indicate a relationship when the gradation level and cumulative time in the first embodiment illustrated in FIG. 15 are used. When the gradation level and the cumulative time are made proportional to each other, the longer the cumulative time is and the darker the gradation is, the more the response characteristic of liquid crystal is degraded, and therefore, there arises a problem that a dark gradation becomes hard to achieve and an image with a sufficient contrast cannot be obtained.

Because of this, in the first embodiment, the difference between the cumulative values of neighboring gradation levels is set to 2 for the gradation levels 15 to 8, however, the difference between the cumulative values of neighboring gradation levels is set to 6 for the gradation levels 8 to 0. Due to this, the nonlinearity of the response characteristic of liquid crystal in a dark gradation is compensated for and an excellent gradation display can be obtained in the entire range.

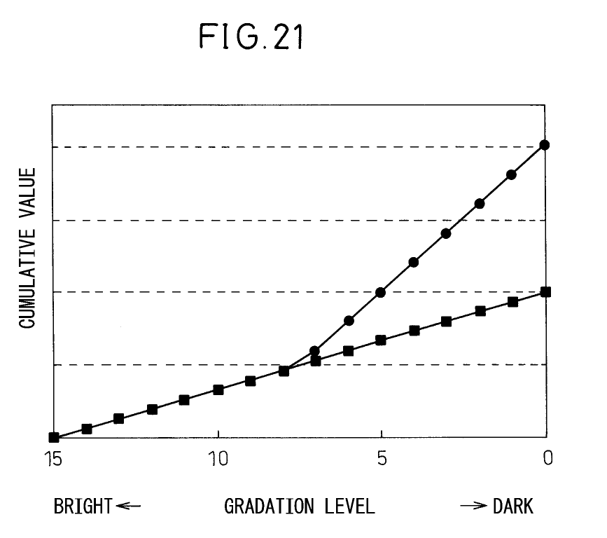

FIG. 21 is a diagram illustrating a relationship between gradation level and cumulative value (time), also illustrating an example in which the cumulative value of a neighboring gradation is doubled on the side toward darker gradation levels from the intermediate gradation level than that on the brighter side.

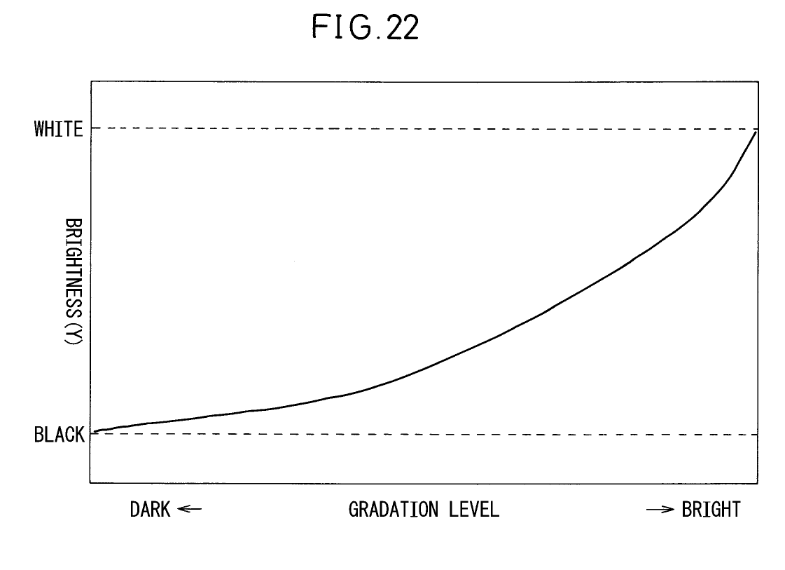

FIG. 22 is a diagram illustrating a relationship between the input gradation level and the brightness in the first embodiment. As illustrated schematically, it can be seen that an excellent tone curve of the gradation with no skip can be obtained.

With the display device in the first embodiment, it is possible to realize a high-speed display mode called a draft mode.

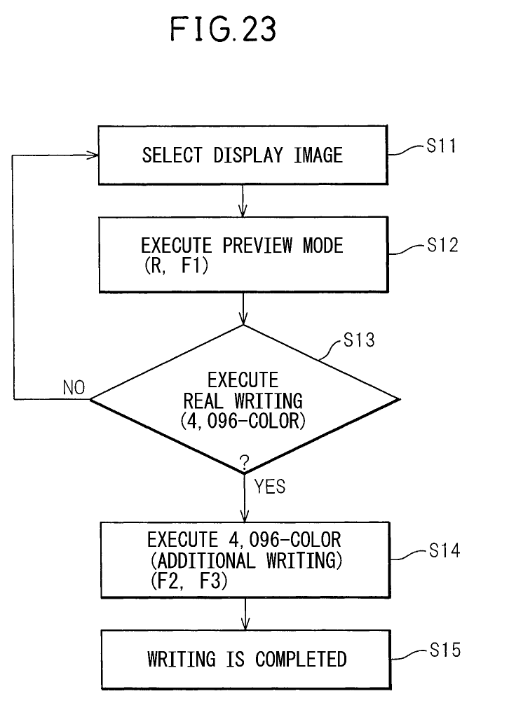

FIG. 23 is a flowchart illustrating the operation sequence in the case of a draft mode.

In step S1, a display image is selected.

In step S2, a preview mode is performed. In the preview mode, the first step S1 and the frame F1 are performed. Due to this, each color of RGB is displayed in 8 bits and a 512-color display is produced in a pseudo manner. This state is a transition state to a 4,096-color display, however, it sufficiently contributes to the recognition of the display content. If only the preview mode is performed, it is possible to do so in a brief time, and therefore, it is possible for a user to save time by confirming the display content and changing to another image if the display content is not a desired one. Consequently, it is possible for a user to update the display content as if turning pages quickly.

In step S13, a user determines whether to further display a 4,096-color image, and if not, an image is selected back in step S11. If the user desires to further confirm the display content, the frames F2 and F3 are performed to produce a 4,096-color display in step S14 ahead. Due to this, a 4,096-color image of high quality is displayed, and therefore, the procedure proceeds to step S15 and the processing is completed.

Next, a display device in a second embodiment is explained. The display device in the second embodiment has the same configuration as that of the display device in the first embodiment but differs from that in the first embodiment only in a sequence in a sub-step of the second step S2.

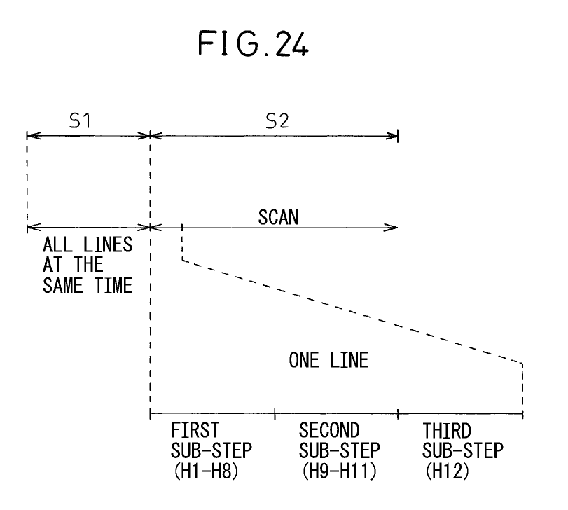

FIG. 24 is a diagram illustrating write processing in the display device in the second embodiment. The first step S1 is the same as that in the first embodiment. In the first embodiment, the second step has the three frames F1 to F3 and in F1, the first sub-step for applying the gradation pulses H1 to H8 to all of the pixels is performed, in F2, the second sub-step for applying the gradation pulses H9 to H11 to all of the pixels is performed, and in F3, the third sub-step for applying the gradation pulse H12 to all of the pixels is performed. That is, the frame processing to apply the scan pulse to all of the scan lines is performed three times.

In contrast to this, in the second embodiment, in a state where one scan line is selected, the first to third sub-steps are performed continuously. In other words, in the state where one scan line is selected, the application of the gradation pulses H1 to H8, H9 to H11, and H12 is performed continuously and after that, the same action is repeated for all of the scan lines. Consequently, the frame processing is performed only once.

At this time, it is preferable to assert /DSPOF to cancel the selected state for a few tens of microseconds to a few tens of milliseconds at the maximum between H8 and H9 and between H11 and H12 in order to suppress the deterioration of the display due to crosstalk.

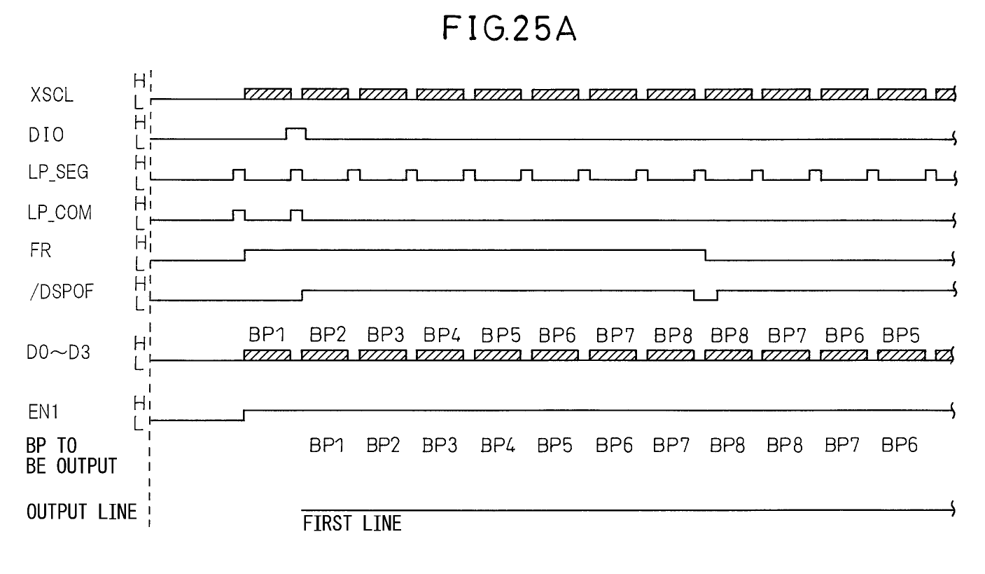

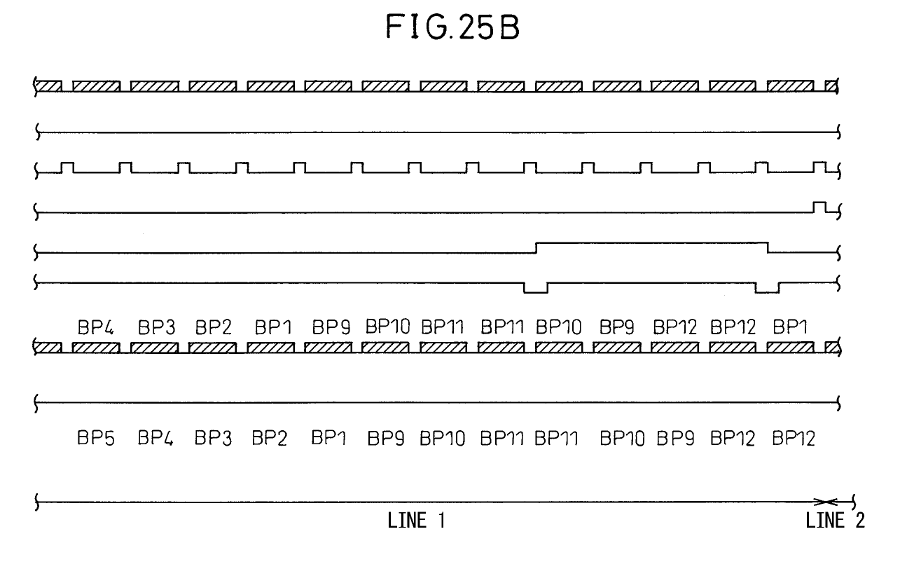

FIG. 25A and FIG. 25B are each a time chart illustrating gradation write processing in the second embodiment. The processing in the second embodiment differs from the processing in the first embodiment in FIG. 17A and FIG. 17B in that the bit planes BP9 to BP11 in the positive polarity phase and BP11 to BP9 in the negative polarity phase, and BP12 in the positive polarity phase and BP12 in the negative polarity phase are further output after the bit planes BP1 to BP8 in the positive polarity phase and BP8 to BP1 in the negative polarity phase are output, and the rest of the processing is the same as that in the first embodiment.

Next, the effect of the embodiments is explained by illustrating an example of the result of measurement, in which power consumption when a halftone is expressed by varying the number of times of application of a pulse with the same pulse width to adjust the cumulative time is compared with that in the first embodiment.

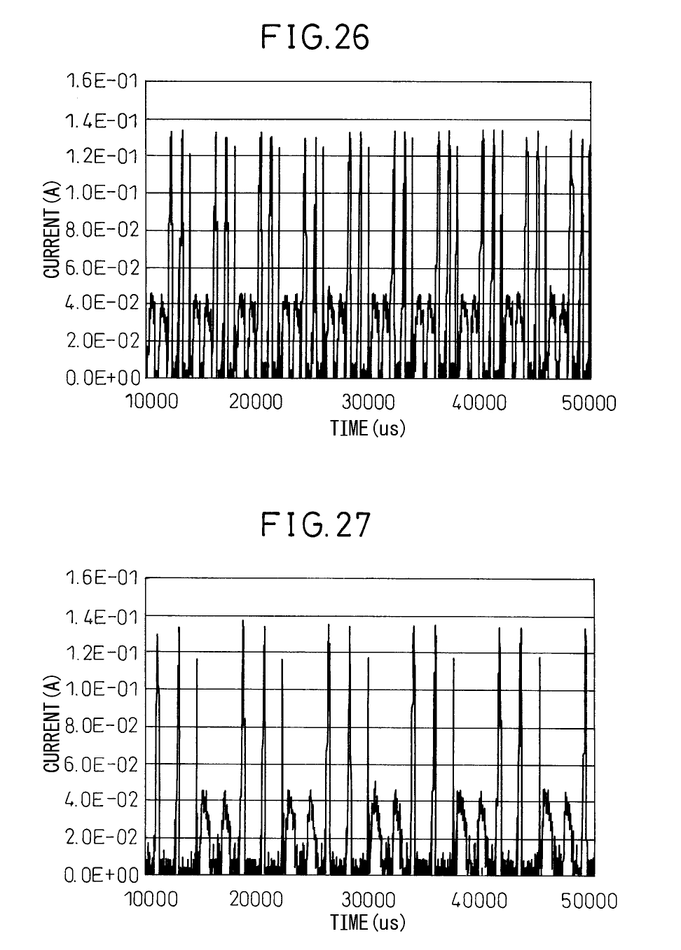

FIG. 26 is a diagram illustrating the change in consumed current at predetermined times when the cumulative time is adjusted only by the number of times of pulse application, and FIG. 27 is a diagram illustrating the change in consumed current under the same conditions in the first embodiment. Here, rewriting of each liquid crystal layer of RGB is performed at the same timing. Further, a test pattern is a solidly shaded black pattern and the current when the solidly shaded black pattern writing is started after resetting is measured. In both the cases, the circuit configuration is the same and only the control sequences of the control circuit are different. The measurement point is the output of the step-up part 22 in FIG. 9 and the total value of the power consumption of the voltage switching part 23, the voltage stabilization part 24, and the common driver 28 and the segment driver 29.

The display element is a capacitive load, and therefore, a large rush current of charge/discharge flows at the time of the rise and fall of the pulse. In the example in FIG. 6, in which only the number of times of pulse application is varied, it can be seen that the rush current flows in accordance with the number of times because a gradation is written by applying a fine pulse a number of times. In contrast to this, in the case of the first embodiment, the number of times of occurrence of a large rush current is reduced.

According to the result of the measurement of the effective power, in the example in FIG. 26 in which only the number of times of pulse application is varied, the power is 653 mW, however, the power is 401 mW in the first embodiment, and therefore, it has been confirmed that the power consumption can be reduced by about 40%. The power consumption is a value including that of the voltage switching part 23, the voltage stabilization part 24, and the common driver 28 and the segment driver 29, and it is needless to say that the power consumption changes accordingly when the kind or configuration of the analog switch, the operational amplifier, and the driver IC is different, however, it is obvious that the power consumption can be reduced in the embodiments.

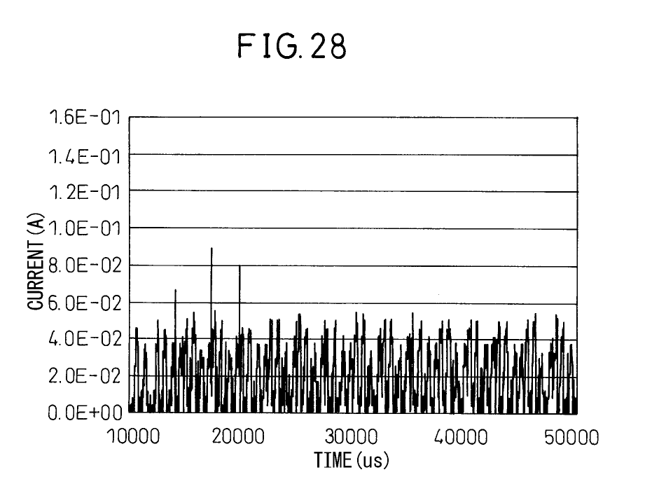

Next, the result of the measurement in which the rewrite timing of each liquid crystal layer of RGB is shifted is illustrated in FIG. 28. In this measurement, the timing of scan is shifted by about ⅓ of the time of each bit plane between R, G and B in order to suppress a rush current. As a result, although the effective power remains unchanged whether the rewrite timing of each liquid layer of RGB is shifted or not, the peak current can be suppressed by about ⅓ by shifting the timing. If the peak current can be suppressed, it is made possible to use a battery having a small current capacity, and therefore, its manufacturing cost can be reduced accordingly.

As described above, according to the embodiments, it is possible to realize a driving method the power consumption of which is small, the display quality of which is excellent, and which is capable of high-speed display by using an inexpensive general-purpose driver for a display element that uses cholesteric liquid crystal.

The embodiments are explained as above, however, it is obvious that there can also be various embodiments. For example, the embodiments can be applied to any display element of dot matrix type as long as it has memory properties, in addition to the display element that uses cholesteric liquid crystal.

Further, the setting values of the voltage/pulse width, the configuration of the bit plane, and the division of the frame in the sub-steps of the second step are not limited to the embodiments and it is obvious that they should be determined in accordance with the specifications of the target element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment of the present invention have been described in detail, it should be understood that the various changes, substitutions, and alterations could be made hereto without departing from the spirit and scope of the invention.

What is claimed is:

1. A display device comprising:
a display element of dot matrix type including a display material with memory properties;
a drive circuit that drives a pixel of the display element; and
a control circuit that controls the drive circuit, wherein:
the control circuit comprises: an initialization step for applying a voltage pulse to initialize a pixel to be rewritten to bring about an initial gradation state; and a gradation step for applying a voltage pulse to change the gradation state of a pixel; and
the gradation step comprises a plurality of sub-steps including a plurality of execution times and in the plurality of sub-steps, an alternating-current voltage pulse is formed in a pixel to be rewritten and the period of the alternating-current voltage pulse is varied in accordance to a gradation to be written within the range of the sub-step.

2. The display device according to claim 1, wherein
the plurality of sub-steps are performed in different frames.

3. The display device according to claim 2, wherein
the plurality of sub-steps are performed in the frames in the order of decreasing number of gradations to be written.

4. The display device according to claim 3, wherein
the plurality of sub-steps are terminated temporarily at the point of time when wiring in a predetermined sub-step is completed.

5. The display device according to claim 1, wherein the alternating-current voltage pulse is formed only in one cycle during the period of selection of a scan line.

6. The display device according to claim 5, wherein
the alternating-current voltage pulse includes a positive polarity phase and a negative polarity phase of the same length.

7. The display device according to claim 1, wherein the drive circuit comprises a driver IC that outputs two values for the pixel of the selected scan line.

8. The display device according to claim 1, wherein
the period of the alternating-current voltage pulse is determined by data to be supplied to a segment driver IC.

9. The display device according to claim 1, wherein
the execution time of the sub-step is controlled by switching the latch periods of the segment driver IC.

10. The display device according to claim 1, wherein
the display material is liquid crystal that forms a cholesteric phase.

11. The display device according to claim 10, wherein
the initial gradation state in the initialization step is a planar state, the gradation state in the gradation step is a state where the planar state and a focal conic state coexist in a mixed condition, and a halftone value is determined by a coexistence ratio.

12. The display device according to claim 11, wherein
a difference of the period of the alternating-current voltage pulse from that of a neighboring gradation is larger when the coexistence ratio of the focal conic state is large than when the coexistence ratio of the focal conic state is small.

13. The display device according to claim 1, wherein
the display device comprises a laminated structure in which a plurality of display elements that exhibit a plurality of kinds of reflected light are stacked.

14. The display device according to claim 1, wherein
in the display device, the operation timing at which the plurality of display elements are brought into the initial gradation state is different from the operation timing at which the state is brought into a gradation state other than the initial gradation state.

15. A driving method of a display device, the device comprising:
a display element of dot matrix type including a display material with memory properties;
a drive circuit that drives a pixel of the display element; and
a control circuit that controls the drive circuit, wherein:
the control circuit comprises an initialization step for applying a voltage pulse to initialize a pixel to be rewritten to bring about the initial gradation state and a gradation step for applying a voltage pulse to change the gradation state of the pixel; and
the gradation step comprises a plurality of sub-steps including a plurality of execution times, in the plurality of sub-steps, an alternating-current voltage pulse is formed in a pixel to be rewritten, and the period of the alternating-current voltage pulse is varied in accordance with a gradation to be written within the range of the sub-step.

16. The driving method according to claim 15, wherein
the plurality of sub-steps are performed in different frames.

17. The driving method according to claim 15, wherein
the alternating-current voltage pulse is formed only in one cycle during the period of selection of a scan line.

18. The driving method according to claim 17, wherein
the alternating-current voltage pulse includes a positive polarity phase and a negative polarity phase of the same length.

19. The driving method according to claim 15 wherein
the display material is liquid crystal that forms a cholesteric phase.

20. The driving method according to claim 19, wherein
the initial gradation state in the initialization step is a planar state, the gradation state in the gradation step is a state where the planar state and a focal conic state coexist in a mixed condition, and a halftone value is determined by a coexistence ratio.
